(19) United States
(12) Patent Application Publication
(10) Pub. No.: US 2015/0161587 A1
(43) Pub. Date: Jun. 11, 2015

(54) PROVISIONING AND AUTHENTICATING CREDENTIALS ON AN ELECTRONIC DEVICE

(71) Applicant: Apple Inc., Cupertino, CA (US)

(72) Inventors: Ahmer A. Khan, Cupertino, CA (US); Joakim Linde, Cupertino, CA (US); Zachary A. Rosen, Cupertino, CA (US); Timothy S. Hurley, Cupertino, CA (US)

(21) Appl. No.: 14/475,260

(22) Filed: Sep. 2, 2014

Related U.S. Application Data
(60) Provisional application No. 61/912,727, filed on Dec. 6, 2013.

(51) Int. Cl. G06Q 20/32; G06Q 20/40

(52) U.S. Cl. CPC G06Q 20/3226; G06Q 20/40; G06Q 20/3223; G06Q 20/3278

(57) ABSTRACT

Systems, methods, and computer-readable media for provisioning and/or authenticating credentials are provided. In one example embodiment, a financial institution system may be in communication with an electronic device and a merchant subsystem. The financial institution system may be configured to, inter alia, create a link between an actual commerce credential and a virtual commerce credential, provision the virtual commerce credential on the electronic device, after the virtual commerce credential is provisioned on the electronic device, receive a transaction request from the merchant subsystem, identify the virtual commerce credential from the received transaction request, and, in response to the identification of the virtual commerce credential, determine if the link between the actual commerce credential and the virtual commerce credential is authenticated for use in a financial transaction. Additional embodiments are also provided.

### CROSS-REFERENCE TO RELATED APPLICATIONS

This application claims the benefit of prior filed U.S. Provisional Patent Application No. 61/912,727, filed Dec. 6, 2013, which is hereby incorporated by reference herein in its entirety.

### TECHNICAL FIELD

This disclosure relates to the provisioning and authentication of credentials on an electronic device and, more particularly, to the provisioning and authentication of virtual commerce credentials on an electronic device.

### BACKGROUND OF THE DISCLOSURE

Portable electronic devices (e.g., cellular telephones) may be provided with near field communication (“NFC”) components for enabling contactless proximity-based communications with another entity. Often times, these communications are associated with financial transactions or other secure data transactions that require the electronic device to access and share a commerce credential, such as a credit card credential or a public transportation ticket credential. However, such contactless proximity-based communications often expose such commerce credentials to interception by rogue entities.

### SUMMARY OF THE DISCLOSURE

This document describes systems, methods, and computer-readable media for provisioning and authenticating credentials on an electronic device that is capable of near field communications and/or other wireless communications.

For example, a financial institution system may be in communication with an electronic device and a merchant subsystem. The financial institution system may include at least one processor component, at least one memory component, and at least one communications component, where the financial institution system may be configured to create a link between an actual commerce credential and a virtual commerce credential, provision the virtual commerce credential on the electronic device, after the virtual commerce credential is provisioned on the electronic device, receive a transaction request from the merchant subsystem, identify the virtual commerce credential from the received transaction request, and, in response to the identification of the virtual commerce credential, determine if the link between the actual commerce credential and the virtual commerce credential is authenticated for use in a financial transaction.

As another example, a method may include creating with a financial institution subsystem a link between an actual commerce credential and a virtual commerce credential. After the creating, the method may also include facilitating the provisioning of the virtual commerce credential on an electronic device using the financial institution subsystem. After the provisioning of the virtual commerce credential on the electronic device, the method may also include authenticating the link between the actual commerce credential and the virtual commerce credential using the financial institution subsystem.

As yet another example, a merchant system may be in communication with an electronic device and a financial institution subsystem. The merchant system may include a processor component, a memory component, and a communications component, where the merchant system may be configured to receive a contactless proximity-based communication from the electronic device, transmit information indicative of a device commerce credential of the received communication to the financial institution subsystem, receive an authorization request from the financial institution subsystem based on the transmitted information, and prompt a user of the electronic device to provide authentication information for an actual commerce credential based on the received authorization request.

As yet another example, a financial institution system may be in communication with a merchant subsystem. The financial institution system may include at least one processor component, at least one memory component, and at least one communications component, where the financial institution system may be configured to receive a virtual commerce credential from a merchant subsystem, detect a link between the received virtual commerce credential and an actual commerce credential, and determine if the detected link is authenticated.

As yet another example, a non-transitory computer-readable medium may include computer-readable instructions recorded thereon for detecting a link between a virtual commerce credential and an actual commerce credential, and determining if the detected link is authenticated.

As yet another example, a financial institution system may be in communication with at least one of an electronic device and a merchant subsystem. The financial institution system may include at least one processor component, at least one memory component, and at least one communications component, where the financial institution system may be configured to create a link between an actual commerce credential and a virtual commerce credential, facilitate the provisioning of the virtual commerce credential on the electronic device, and authenticate the link between the actual commerce credential and the virtual commerce credential after the provisioning of the virtual commerce credential on the electronic device.

This Summary is provided merely to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for provisioning and authenticating credentials on an electronic device;

FIG. 2 is a more detailed schematic view of the electronic device of the system of FIG. 1;

FIG. 3 is a front view of the electronic device of FIGS. 1 and 2;

FIG. 4 is a more detailed schematic view of the commercial entity subsystem of the system of FIG. 1;

FIGS. 5-6 are flowcharts of illustrative processes for provisioning and authenticating credentials on an electronic device; and

FIG. 7 shows an illustrative data structure of the system of FIG. 1 that may be used for provisioning and authenticating credentials on an electronic device.

### DETAILED DESCRIPTION OF THE DISCLOSURE

The provisioning of a commerce credential on an electronic device for later use in a secure data transaction may include a financial institution identifying an actual commerce credential, linking that actual commerce credential with a virtual commerce credential, and provisioning that virtual commerce credential rather than the actual commerce credential on the electronic device. Later, when a merchant receives a financial transaction request from the electronic device (e.g., as a contactless proximity-based communication) that includes the virtual commerce credential, the merchant may forward to the financial institution the financial transaction request with the virtual commerce credential, and then the financial institution may identify the actual commerce credential that was previously linked to that virtual commerce credential and may attempt to fund the financial transaction request using that actual commerce credential. The link between the virtual commerce credential and the actual commerce credential may be created but not authenticated when the virtual commerce credential is provisioned on the electronic device, such that the first time the electronic device uses the provisioned virtual commerce credential in a financial transaction request, the financial institution may detect the actual commerce credential linked to that virtual commerce credential but may determine that the link has not yet been authenticated. In such cases, before attempting to fund the financial transaction request using that linked but non-authenticated actual commerce credential, the financial institution may leverage the merchant to obtain the necessary information from the user of the electronic device for properly authenticating the link.

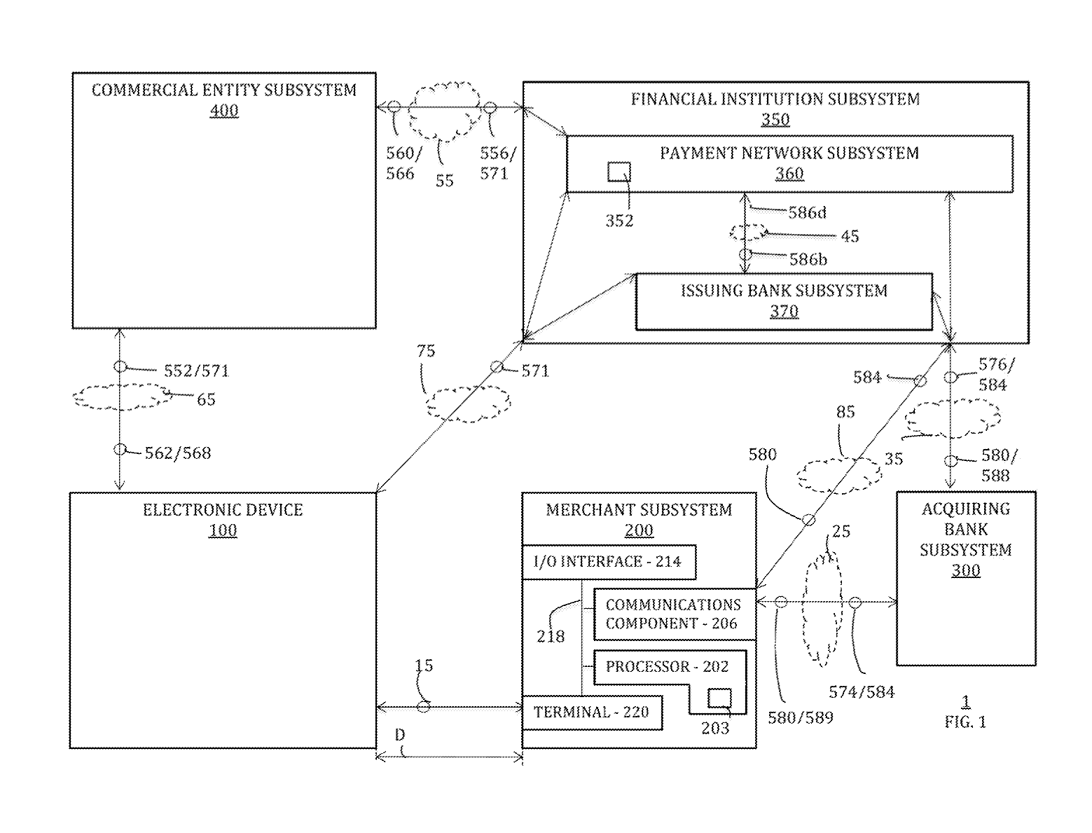

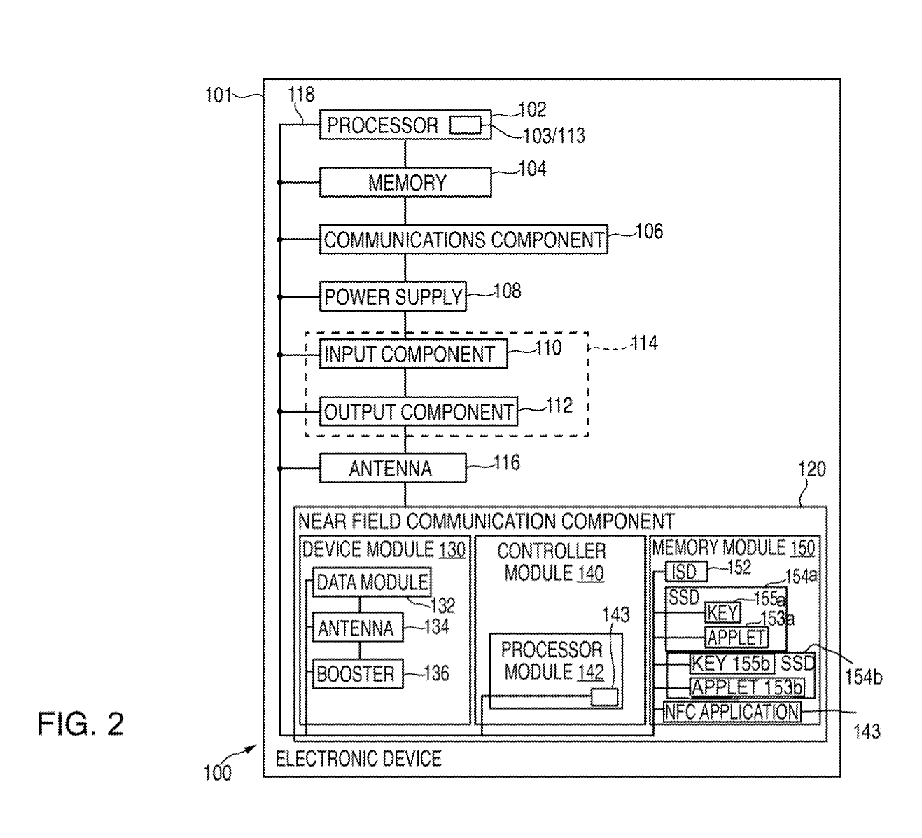

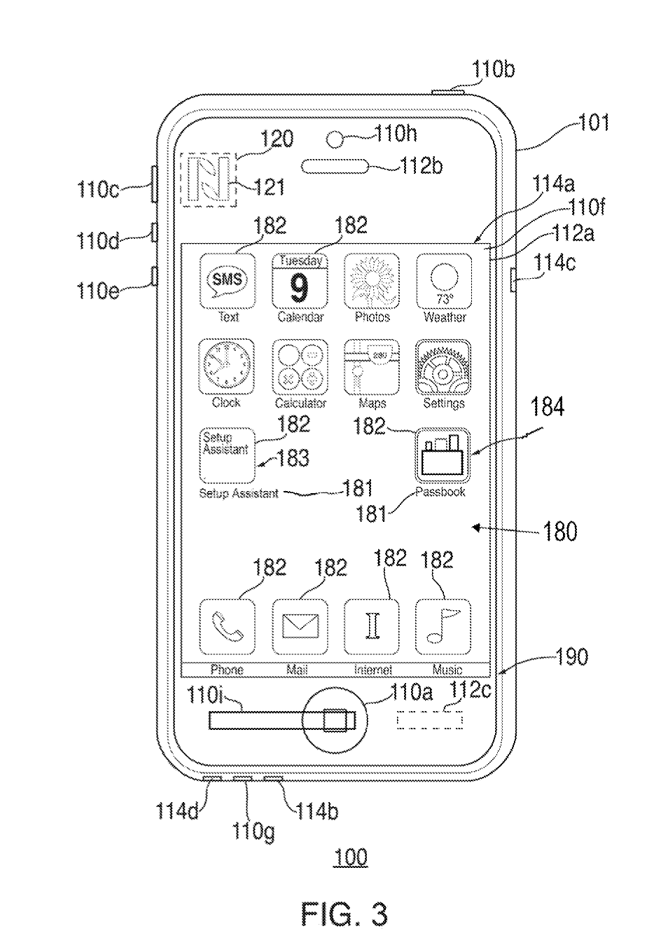

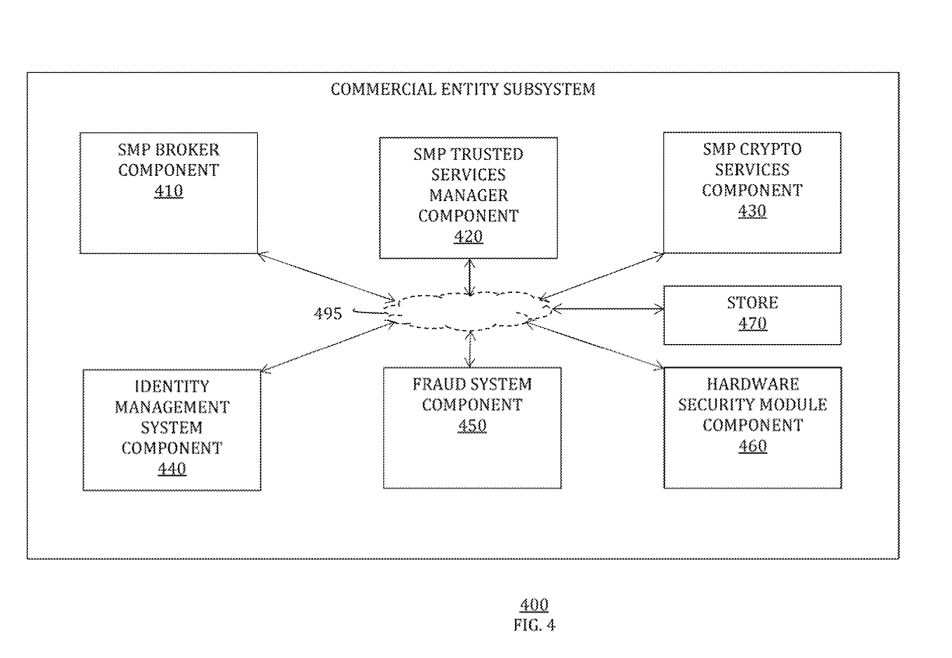

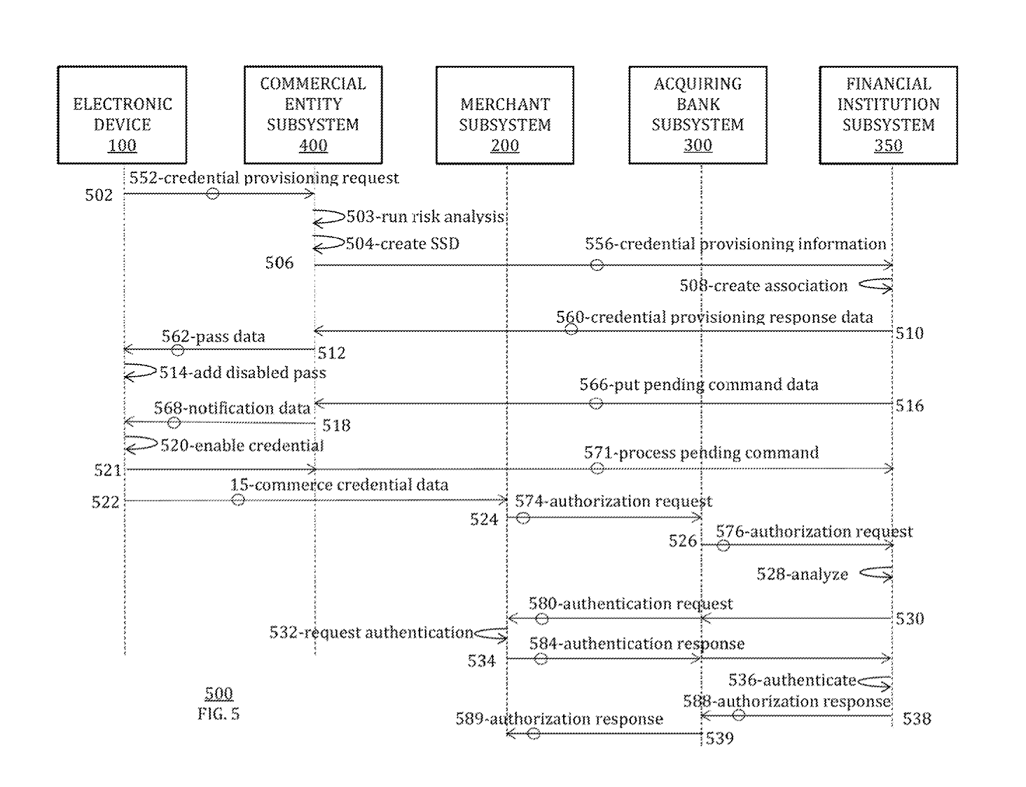

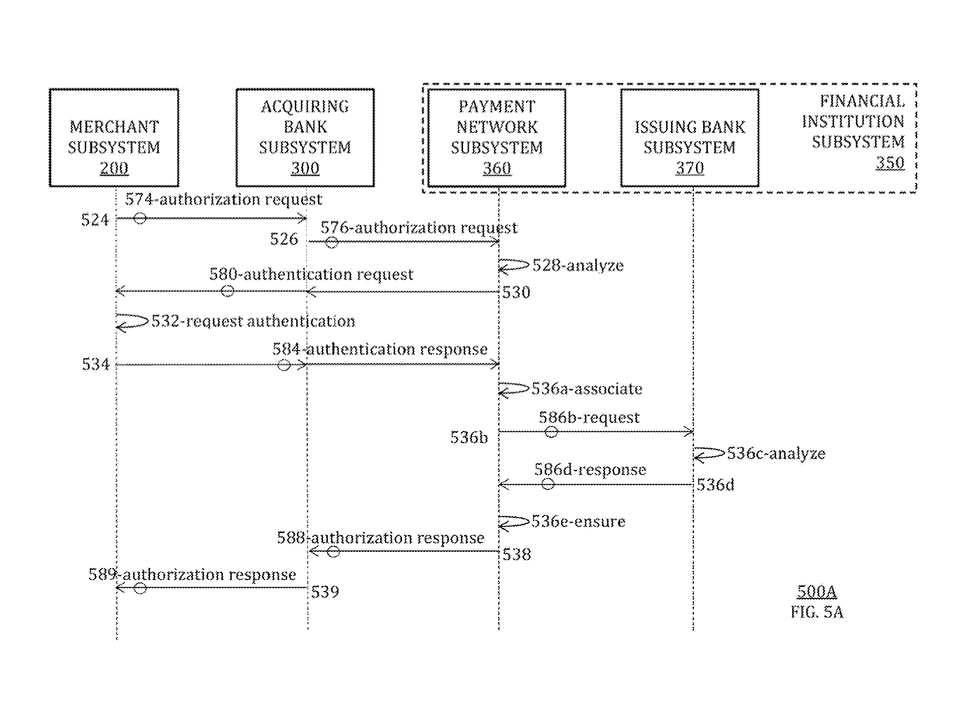

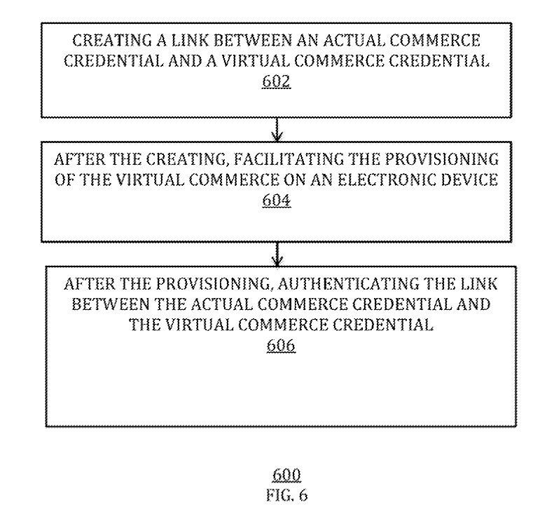

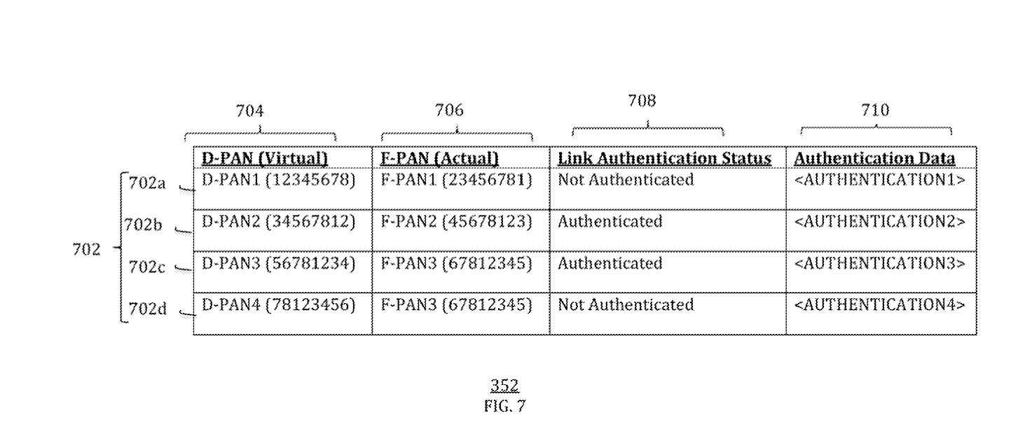

FIG. 1 shows a system 1 in which one or more credentials may be provisioned on an electronic device 100 from a financial institution subsystem 350 (e.g., in conjunction with a commercial entity subsystem 400), and in which such credentials may be used by electronic device 100 for conducting a commercial transaction with a merchant subsystem 200 and an associated acquiring bank subsystem 300. FIGS. 2 and 3 show further details with respect to particular embodiments of electronic device 100 of system 1, while FIG. 4 shows further details with respect to particular embodiments of commercial entity subsystem 400 of system 1. FIGS. 5-6 are flowcharts of illustrative processes for provisioning and authenticating credentials on electronic device 100 in the context of system 1, and FIG. 7 shows an illustrative data structure 352 of the system of FIG. 1 that may be used for provisioning and authenticating credentials on electronic device 100.

### Description of FIG. 1. FIG. 2, FIG. 3. And FIG. 4

FIG. 1 is a schematic view of an illustrative system 1 that may allow for the secure provisioning of credentials on an electronic device and/or for the authenticating of such credentials that may allow for the use of such credentials in a commercial or financial transaction. For example, as shown in FIG. 1, system 1 may include an end-user electronic device 100 as well as a commercial entity subsystem 400 and a financial institution subsystem 350 for securely provisioning credentials on electronic device 100. Moreover, as shown in FIG. 1, system 1 may also include a merchant subsystem 200 for receiving contactless proximity-based communications 15 (e.g., near field communications) from electronic device 100 based on such provisioned credentials, as well as an acquiring bank subsystem 300 that may utilize such contactless proximity-based communications 15 for completing a transaction with financial institution subsystem 350. Merchant subsystem 200 may also be configured to enable user authentication of a provisioned credential during a transaction.

As shown in FIG. 2, and as described in more detail below, electronic device 100 may include a processor 102, memory 104, communications component 106, power supply 108, input component 110, output component 112, antenna 116, and near field communication (“NFC”) component 120, where input component 110 and output component 112 may sometimes be a single I/O component or I/O interface 114, such as a touch screen, that may receive input information through a user's touch of a display screen and that may also provide visual information to a user via that same display screen. Electronic device 100 may also include a bus 118 that may provide one or more wired or wireless communication links or paths for transferring data and/or power to, from, or between various other components of device 100. Electronic device 100 may also be provided with a housing 101 that may at least partially enclose one or more of the components of device 100 for protection from debris and other degrading forces external to device 100. Processor 102 may be used to run one or more applications, such as an application 103 and/or an application 113. Each one of applications 103 and 113 may include, but is not limited to, one or more operating system applications, firmware applications, media playback applications, media editing applications, communication applications (e.g., short message service (“SMS”) or text messaging application, telephone communication application, e-mail application, internet application, etc.), NFC applications, biometric feature-processing applications, or any other suitable applications. For example, processor 102 may load an application 103/113 as a user interface program to determine how instructions or data received via an input component 110 or other component of device 100 may manipulate the way in which information may be stored and/or provided to the user via an output component 112. As one example, application 103 may be an operating system application while application 113 may be a third party application (e.g., an application associated with a merchant of merchant subsystem 200 and/or an application associated with a financial institution of financial institution subsystem 350 and/or an application generated and/or maintained by commercial entity subsystem 400). NFC component 120 may be any suitable proximity-based communication mechanism that may enable any suitable contactless proximity-based transactions or communications 15 between electronic device 100 and merchant subsystem 200 (e.g., a merchant payment terminal 220 of merchant subsystem 200). NFC component 120 may include any suitable modules for enabling contactless proximity-based communication 15 between electronic device 100 and subsystem 200. As shown in FIG. 2, for example, NFC component 120 may include an NFC device module 130, an NFC controller module 140, and an NFC memory module 150. NFC device module 130 may include an NFC data module 132, an NFC antenna 134, and an NFC booster 136. NFC controller module 140 may include at least one NFC processor module 142 that may be used to run one or more applications, such as an NFC low power mode or wallet application 143 that may help dictate the function of NFC component 120. NFC memory module 150 may operate in conjunction with NFC device module 130 and/or NFC controller module 140 to allow for NFC communication 15 between electronic device 100 and merchant subsystem 200. NFC memory module 150 may be tamper resistant and may provide at least a portion of a secure element. For example, such a secure element may be configured to provide a tamper-resistant platform (e.g., as a single or multiple chip secure microcontroller) that may be capable of securely hosting applications and their confidential and cryptographic data (e.g., applet 153 and key 155) in accordance with rules and security requirements that may be set forth by a set of well-identified trusted authorities (e.g., an authority of financial institution subsystem and/or an industry standard, such as GlobalPlatform). NFC memory module 150 may include one or more of an issuer security domain (“ISD”) 152 and a supplemental security domain (“SSD”) 154 (e.g., a service provider security domain (“SPSD”), a trusted service manager security domain (“TSMSD”), etc.), which may be defined and managed by an NFC specification standard (e.g., GlobalPlatform). For example, ISD 152 may be a portion of NFC memory module 150 in which a trusted service manager (“TSM”) or issuing financial institution may store keys and/or other suitable information for creating or otherwise provisioning one or more credentials (e.g., credentials associated with various credit cards, bank cards, gift cards, access cards, transit passes, etc.) on electronic device 100 (e.g., via communications component 106), for credential content management, and/or security domain management. A specific supplemental security domain (“SSD”) 154 (e.g., one of SSDs 154a and 154b) may be associated with a specific credential (e.g., a specific credit card credential or a specific public transit card credential) that may provide specific privileges or payment rights to electronic device 100. Each SSD 154 may have its own manager key 155 (e.g., a respective one of keys 155a and 155b) for its own application or applet 153 (e.g., a respective one of applets 153a and 153b) that may need to be activated to enable a specific credential of that SSD 154 for use by NFC device module 130 as an NFC communication 15 between electronic device 100 and merchant subsystem 200.

Merchant subsystem 200 of FIG. 1 may include a reader or terminal 220 for detecting, reading, or otherwise receiving NFC communication 15 from electronic device 100 (e.g., when electronic device 100 comes within a certain distance or proximity D of terminal 220). Accordingly, it is noted that NFC communication 15 between merchant terminal 220 and electronic device 100 may occur wirelessly and, as such, may not require a clear “line of sight” between the respective devices. NFC device module 130 may be passive or active. When passive, NFC device module 130 may only be activated when within a response range D of a suitable terminal 220 of merchant subsystem 200. For instance, terminal 220 of merchant subsystem 200 may emit a relatively low-power radio wave field that may be used to power an antenna utilized by NFC device module 130 (e.g., shared antenna 116 or NFC-specific antenna 134) and, thereby, enable that antenna to transmit suitable NFC communication information (e.g., credit card credential information) from NFC data module 132, via antenna 116 or antenna 134, to terminal 220 of merchant subsystem 200 as NFC communication 15. When active, NFC device module 130 may incorporate or otherwise have access to a power source local to electronic device 100 (e.g., power supply 108) that may enable shared antenna 116 or NFC-specific antenna 134 to actively transmit NFC communication information (e.g., credit card credential information) from NFC data module 132, via antenna 116 or antenna 134, to terminal 220 of merchant subsystem 200 as NFC communication 15, rather than reflect radio frequency signals, as in the case of a passive NFC device module 130. As also shown in FIG. 1, and as described below in more detail, merchant subsystem 200 may also include a merchant processor component 202 that may be the same as or similar to a processor component 102 of electronic device 100, a merchant application 203 that may be the same as or similar to an application 103/113 of electronic device 100, a merchant communications component 206 that may be the same as or similar to a communications component 106 of electronic device 100, a merchant I/O interface 214 that may be the same as or similar to an I/O interface 114 of electronic device 100, a merchant bus 218 that may be the same as or similar to a bus 118 of electronic device 100, a merchant memory component (not shown) that may be the same as or similar to a memory component 104 of electronic device 100, and/or a merchant power supply component (not shown) that may be the same as or similar to a power supply component 108 of electronic device 100.

As shown in FIG. 3, and as described below in more detail, a specific example of electronic device 100 may be a handheld electronic device, such as an iPhone™, where housing 101 may allow access to various input components 110a-110i, various output components 112a-112c, and various I/O components 114a-114d through which device 100 and a user and/or an ambient environment may interface with each other. For example, a touch screen I/O component 114a may include a display output component 112a and an associated touch input component 110f, where display output component 112a may be used to display a visual or graphic user interface (“GUI”) 180, which may allow a user to interact with electronic device 100. GUI 180 may include various layers, windows, screens, templates, elements, menus, and/or other components of a currently running application (e.g., application 103 and/or application 113 and/or application 143) that may be displayed in all or some of the areas of display output component 112a. For example, as shown in FIG. 3, GUI 180 may be configured to display a first screen 190 with one or more graphical elements or icons 182 of GUI 180. When a specific icon 182 is selected, device 100 may be configured to open a new application associated with that icon 182 and display a corresponding screen of GUI 180 associated with that application. For example, when the specific icon 182 labeled with a “Setup Assistant” textual indicator 181 (i.e., specific icon 183) is selected, device 100 may launch or otherwise access a specific setup application and may display screens of a specific user interface that may include one or more tools or features for interacting with device 100 in a specific manner.

Referring back to system 1 of FIG. 1, when NFC component 120 is appropriately enabled to communicate NFC communication 15 to merchant subsystem 200 with commerce credential data associated with an enabled credential of device 100 (e.g., commerce credential data associated with an enabled applet 153 of an SSD 154 of NFC component 120), acquiring bank subsystem 300 may utilize such commerce credential data of NFC communication 15 for completing a commercial or financial transaction with financial institution subsystem 350 (e.g., as described below in more detail). Financial institution subsystem 350 may include a payment network subsystem 360 (e.g., a payment card association or a credit card association) and/or an issuing bank subsystem 370. For example, issuing bank subsystem 370 may be a financial institution that assumes primary liability for a consumer's capacity to pay off debts they incur with a specific credential. Each specific credential may be associated with a specific payment card that may be electronically linked to an account or accounts of a particular user. Various types of payment cards are suitable, including credit cards, debit cards, charge cards, stored-value cards, fleet cards, gift cards, and the like. The commerce credential of a specific payment card may be provisioned on electronic device 100 by issuing bank subsystem 370 for use in an NFC communication 15 with merchant subsystem 200. Each credential may be a specific brand of payment card that may be branded by a payment network subsystem 360. Payment network subsystem 360 may be a network of various issuing banks 370 and/or various acquiring banks that may process the use of payment cards (e.g., commerce credentials) of a specific brand. Alternatively or additionally, certain credentials that may be provisioned on device 100 for use in a commercial or financial transaction may be electronically linked to or otherwise associated with an account or accounts of a particular user, but not associated with any payment card. For example, a bank account or other financial account of a user may be associated with a credential provisioned on device 100 but may not be associated with any payment card.

Payment network subsystem 360 and issuing bank subsystem 370 may be a single entity or separate entities. For example, American Express may be both a payment network subsystem 360 and an issuing bank subsystem 370. In contrast, Visa and MasterCard may be payment network subsystems 360, and may work in cooperation with issuing bank subsystems 370, such as Chase, Wells Fargo, Bank of America, and the like. Financial institution subsystem 350 may also include one or more acquiring banks, such as acquiring bank subsystem 300. For example, acquiring bank subsystem 300 may be the same entity as issuing bank subsystem 370. One, some, or all components of payment network subsystem 360 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of issuing bank subsystem 370 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

To facilitate transactions within system 1, one or more commerce credentials may be provisioned on electronic device 100. However, before provisioning a credential on device 100, a user of device 100 may attempt to prove that he or she is an authorized user of the credential and that the credential is in good standing. As shown in FIG. 1, commercial entity subsystem 400 may be provided within system 1, where commercial entity subsystem 400 may be configured to provide a new layer of security and/or to provide a more seamless user experience when it is being determined whether or not to provision a credential from financial institution subsystem 350 on device 100. Commercial entity subsystem 400 may be provided by a specific commercial entity that may offer various services to a user of device 100. As just one example, commercial entity subsystem 400 may be provided by Apple Inc. of Cupertino, Calif., which may also be a provider of various services to users of device 100 (e.g., the iTunes™ Store for selling/renting media to be played by device 100, the Apple App Store™ for selling/renting applications for use on device 100, the Apple iCloud™ Service for storing data from device 100, the Apple Online Store for buying various Apple products online, etc.), and which may also be a provider, manufacturer, and/or developer of device 100 itself (e.g., when device 100 is an iPod™, iPad™, iPhone™, or the like). Additionally or alternatively, commercial entity subsystem 400 may be provided by a network operator (e.g., a mobile network operator, such as Verizon or AT&T, which may have a relationship with a user of device 100 (e.g., a data plan for enabling the communication of data over a certain communication path and/or using a certain communication protocol with device 100)).

The commercial entity that may provide, manage, or at least partially control commercial entity subsystem 400 may also provide different users with their own personalized accounts for using the services offered by that commercial entity. Each user account with the commercial entity may be associated with a specific personalized user ID and password that a user may use to log-in to their account with the commercial entity. Each user account with the commercial entity may also be associated with or have access to at least one commerce credential that can then be used by the user for purchasing services or products offered by the commercial entity. For example, each Apple ID user account may be associated with at least one credit card of a user associated with that Apple ID, such that the credit card may then be used by the user of that Apple ID account for procuring services from Apple's iTunes™ Store, the Apple App Store™, the Apple iCloud™ Service, and the like. The commercial entity that may provide, manage, or at least partially control commercial entity subsystem 400 (e.g., Apple Inc.) may be distinct and independent from any financial entity of financial institution subsystem 350. For example, the commercial entity that may provide, manage, or at least partially control commercial entity subsystem 400 may be distinct and independent from any payment network subsystem 360 or issuing bank subsystem 370 that may furnish and manage any credit card or other commerce credential associated with a user account of the commercial entity. Similarly, the commercial entity that may provide, manage, or at least partially control commercial entity subsystem 400 may be distinct and independent from any payment network subsystem 360 or issuing bank subsystem 370 that may furnish and manage any commerce credential to be provisioned on user device 100. Such a commercial entity may leverage the known commerce credential information associated with each of its user accounts and/or any suitable information that commercial entity subsystem 400 may determine about device 100 (e.g., various communication mechanisms enabled by device 100) in order to more securely determine with commercial entity subsystem 400 whether a specific credential offered by financial institution subsystem 350 ought to be provisioned on a user device 100. Additionally or alternatively, such a commercial entity may leverage its ability to configure or control various components of device 100 (e.g., software and/or hardware components of device 100 when that commercial entity at least partially produces or manages device 100) in order to provide a more seamless user experience for a user of device 100 when he or she wants to provision a credential offered by financial institution subsystem 350 on user device 100. Details regarding an example of how commercial entity subsystem 400 may be implemented are provided below with reference to FIG. 4.

As shown in FIG. 4, commercial entity subsystem 400 may be a secure platform system and may include a secure mobile platform (“SMP”) broker component 410, an SMP trusted services manager (“TSM”) component 420, an SMP crypto services component 430, an identity management system (“IDMS”) component 440, a fraud system component 450, a hardware security module (“HSM”) component 460, and/or a store component 470. One, some, or all components of commercial entity subsystem 400 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100. One, some, or all components of commercial entity subsystem 400 may be managed by, owned by, at least partially controlled by, and/or otherwise provided by a single commercial entity (e.g., Apple Inc.) that may be distinct and independent from financial institution subsystem 350. The components of commercial entity subsystem 400 may interact with each other and collectively with both financial institution subsystem 350 and electronic device 100 for providing a new layer of security and/or for providing a more seamless user experience when it is being determined whether or not to provision a credential from financial institution subsystem 350 on to device 100.

SMP broker component 410 of commercial entity subsystem 400 may be configured to manage user authentication with a commercial entity user account. SMP broker component 410 may also be configured to manage the lifecycle and provisioning of credentials on device 100. SMP broker component 410 may be a primary end point that may control the user interface elements (e.g., elements of GUI 180) on device 100. An operating system or other application of device 100 (e.g., application 103, application 113, and/or application 143) may be configured to call specific application programming interfaces (“APIs”) and SMP broker 410 may be configured to process requests of those APIs and respond with data that may derive the user interface of device 100 and/or respond with application protocol data units (“APDUs”) that may communicate with the secure element of NFC component 120 (e.g., via a communication path 65 between commercial entity subsystem 400 and electronic device 100). Such APDUs may be received by commercial entity subsystem 400 from financial institution subsystem 350 via a trusted services manager (“TSM”) of system 1 (e.g., a TSM of a communication path 55 between commercial entity subsystem 400 and financial institution subsystem 350). SMP TSM component 420 of commercial entity subsystem 400 may be configured to provide GlobalPlatform-based services that may be used to carry out credential provisioning operations on device 100 from financial institution subsystem 350. GlobalPlatform, or any other suitable secure channel protocol, may enable SMP TSM component 420 to properly communicate and/or provision sensitive account data between the secure element of device 100 and a TSM for secure data communication between commercial entity subsystem 400 and financial institution subsystem 350.

SMP TSM component 420 may be configured to use HSM component 460 to protect its keys and generate new keys. SMP crypto services component 430 of commercial entity subsystem 400 may be configured to provide key management and cryptography operations that may be required for user authentication and/or confidential data transmission between various components of system 1. SMP crypto services component 430 may utilize HSM component 460 for secure key storage and/or opaque cryptographic operations. A payment crypto service of SMP crypto services component 430 may be configured to interact with IDMS component 440 to retrieve on-file credit cards or other types of commerce credentials associated with user accounts of the commercial entity. Such a payment crypto service may be configured to be the only component of commercial entity subsystem 400 that may have clear text (i.e., non-hashed) information describing commerce credentials (e.g., credit card numbers) of its user accounts in memory. Commercial entity fraud system component 450 of commercial entity subsystem 400 may be configured to run a commercial entity fraud check on a commerce credential based on data known to the commercial entity about the commerce credential and/or the user (e.g., based on data (e.g., commerce credential information) associated with a user account with the commercial entity and/or any other suitable data that may be under the control of the commercial entity and/or any other suitable data that may not be under the control of financial institution subsystem 350). Commercial entity fraud system component 450 may be configured to determine a commercial entity fraud score for the credential based on various factors or thresholds. Additionally or alternatively, commercial entity subsystem 400 may include a store 470, which may be a provider of various services to users of device 100 (e.g., the iTunes™ Store for selling/renting media to be played by device 100, the Apple App Store™ for selling/renting applications for use on device 100, the Apple iCloud™ Service for storing data from device 100, the Apple Online Store for buying various Apple products online, etc.). As just one example, store 470 may be configured to manage and provide an application 113 to device 100 (e.g., via communications path 65), where application 113 may be any suitable application, such as a banking application, an e-mail application, a text messaging application, an internet application, or any other suitable application. Any suitable communication protocol or combination of communication protocols may be used by commercial entity subsystem 400 to communicate data amongst the various components of commercial entity subsystem 400 (e.g., via at least one communications path 495 of FIG. 4) and/or to communicate data between commercial entity subsystem 400 and other components of system 1 (e.g., financial institution subsystem 350 via communications path 55 of FIG. 1 and/or electronic device 100 via communications path 65 of FIG. 1).

### Description of FIG. 5

FIG. 5 is a flowchart of an illustrative process 500 for provisioning and authenticating a credential on an electronic device. Process 500 is shown being implemented by the various elements of system 1 (e.g., electronic device 100, merchant subsystem 200, acquiring bank subsystem 300, financial institution subsystem 350, and commercial entity subsystem 400). However, it is to be understood that process 500 may be implemented using any other suitable components or subsystems. Process 500 may provide a seamless user experience for provisioning and/or authenticating a credential on device 100 with minimal user interaction with device 100 or any remote entity. Process 500 may begin at step 502, where device 100 may communicate credential provisioning request data 552 with commercial entity subsystem 400, where credential provisioning request data 552 may include a selection of a particular commerce credential to be provisioned on to device 100 as well as any other suitable information associated with device 100. For example, when a user selects a particular commerce credential for provisioning on to device 100 (e.g., through user interaction with GUI 180 on I/O interface 114a of device 100, such as during use of a setup assistant application associated with “Setup Assistant” icon 183 and/or during use of a “Passbook” or “Wallet” application associated with “Passbook” icon 184 of FIG. 3), the selection may be transmitted as at least a portion of credential provisioning request data 552 by device 100 to commercial entity subsystem 400. Such a user selected card request may include any suitable information indicative of the selected credential (e.g., a true or hashed version of a primary account number (“PAN”) associated with the selected commerce credential). Additionally, such a user selected card request of credential provisioning request data 552 may include any suitable security information associated with the selected credential that may be used by financial institution subsystem 350 for provisioning that credential onto device 100 (e.g., the card verification value (“CVV”) for the selected credential, the expiration date for the selected credential, the billing address for the selected credential, etc.). For example, GUI 180 may enable electronic device 100 to prompt the user to authenticate a selected credential in one or more ways (e.g., by entering security information, such as the CNN of the selected credential and/or any other suitable security information that may be required by system 1 (e.g., by financial institution subsystem 350) for provisioning the selected credential on device 100). Moreover, GUI 180 may also prompt the user to consider and accept various terms and conditions that may be applicable for provisioning the selected credential on device 100. Additionally or alternatively, credential provisioning request data 552 may include any other suitable information that may be useful to commercial entity subsystem 400 for enabling the provisioning of the selected credential on device 100 (e.g., an SSD identifier, which may be indicative of an available SSD 154 of NFC component 120 of device 100 that may be able to receive such a provisioned credential). Such a user selected card request may be transmitted by electronic device 100 as at least a portion of credential provisioning request data 552 to commercial entity subsystem 400 (e.g., to SMP broker 410 of commercial entity subsystem 400) via communications path 65 of FIG. 1. For example, communications component 106 of electronic device 100 may be configured to transmit credential provisioning request data 552 using any suitable communications protocol over any suitable communications path 65.

As shown in FIG. 5, after step 502, process 500 may include a step 503, where a risk analysis may be run on the selected commerce credential that may be identified by data 552 of step 502. For example, risk analysis step 503 may include at least one suitable risk assessment on the credential that has been selected to be provisioned, where such risk assessment may take into account specific attributes of device 100 itself. As just one example, the risk analysis of step 503 may include a commercial entity fraud risk analysis that may be conducted by commercial entity subsystem 400 and/or a financial entity fraud risk analysis that may be conducted by financial institution subsystem 350 (e.g., as described in U.S. patent application Ser. No. 14/092,205, filed Nov. 27, 2013, which is hereby incorporated by reference herein). If the credential selected at step 502 for provisioning on device 100 successfully passes the risk analysis of step 503, then commercial entity subsystem 400 may proceed to step 504. However, if a credential selected at step 502 for provisioning on device 100 does not meet suitable risk thresholds of the risk analysis of step 503, commercial entity subsystem 400 may take additional precautionary steps (not shown in FIG. 5) for increasing the confidence with which system 1 may determine that a credential ought to be provisioned on device 100 (e.g., steps may be taken to enable communication of one-time password data between financial institution subsystem 350 and device 100).

In response to receiving a user selected card request as at least a portion of credential provisioning request data 552 at step 502, an SSD may be created by commercial entity subsystem 400 (e.g., by SMP broker component 410) at step 504. For example, an identifier for an SSD of device 100 (e.g., an SSD 154 of NFC component 120) into which the credential is to be provisioned may be created at step 504, where the SSD may be at least partially determined based on the secure element information (e.g., an SSD identifier) that may be provided by request data 552 of step 502. Next, after step 504, commercial entity subsystem 400 (e.g., SMP broker component 410) may send a request to financial institution subsystem 350 for the provisioning of the selected credential on device 100 (e.g., using any suitable communications protocol over any suitable communications path 55 (e.g., via a TSM of path 55)). For example, at step 506 of process 500 of FIG. 5, commercial entity subsystem 400 may generate and transmit credential provisioning instruction data 556 to financial institution subsystem 350 (e.g., to payment network subsystem 360 of financial institution subsystem 350). In some embodiments, such a credential provisioning instruction may only be generated and transmitted if commercial entity subsystem 400 determines that the selected credential ought to be provisioned on device 100. For example, such a determination may be made if the selected credential successfully passes the risk analysis of step 503. Alternatively, if the selected credential does not successfully pass the risk analysis of step 503, commercial entity subsystem 400 may still make a determination to proceed with step 506. Credential provisioning instruction data 556 may include any suitable data that financial institution subsystem 350 may use to begin provisioning the selected credential on device 100, such as data indicative of the selected credential (e.g., secure data for the selected credential (e.g., the credential's PAN of data 552) and/or identification of an available SSD 154 of device 100 (e.g., of step 504) for receiving the provisioned credential, which may be encoded with a security key in a suitable manner for communication by commercial entity subsystem 400 over communication path 55 to financial institution subsystem 350).

In response to receiving such credential provisioning instruction data 556 from commercial entity subsystem 400, financial institution subsystem 350 (e.g., payment network subsystem 360) may be configured to generate a descriptor of the selected credential to be provisioned, as well as visual artwork and other metadata that may be provided on device 100 for aiding user interaction with the credential once provisioned. For example, at step 510 of process 500 of FIG. 5, financial institution subsystem 350 may pull specific data from the credential provisioning instruction data 556 (e.g., the credential identification information for the selected credential), access one or more databases of information available to financial institution subsystem 350 that may be useful for generating one or more descriptors and/or various types of metadata that may aid any eventual user interaction with the credential once provisioned on device 100, and then financial institution subsystem 350 may generate and transmit credential provisioning response data 560 back to commercial entity subsystem 400. Such credential provisioning response data 560 may include a descriptor of the credential to be provisioned and any suitable metadata that ought to be provided on device 100 for aiding user interaction with the credential to be provisioned. For example, such credential provisioning response data 560 may include some or all suitable data that may enable device 100 to make the credential visually appear as available to device 100, such as visual logos/icons and other user discernible data associated with the credential that may be provided to the user (e.g., when the specific icon 182 labeled with a “Passbook” textual indicator 181 (i.e., specific icon 184) of FIG. 3 is selected, device 100 may launch or otherwise access a specific passbook or wallet application and may display screens of a specific user interface that may include one or more visual descriptors of the credential). Such credential provisioning response data 560 generated by financial institution subsystem 350 may be transmitted by financial institution subsystem 350 (e.g., by an appropriate payment network subsystem 360) to commercial entity subsystem 400 (e.g., to SMP broker component 410) via communications path 55 of FIG. 1 using any suitable communications protocol over any suitable communications path type (e.g., via a TSM of communications path 55).

In some embodiments, system 1 and/or process 500 may be configured to provision a virtual credential on device 100 rather than the actual credential that may be identified at step 502 and/or that may be used for the fraud risk analysis of step 503. For example, once it is determined that a credential is to be provisioned on device 100, it may be requested (e.g., by financial institution subsystem 350 at step 508, by commercial entity subsystem 400 at step 506, and/or by a user of device 100 at step 502) that a virtual credential be generated, linked to the actual credential, and provisioned on device 100 instead of the actual credential. That is, commercial entity subsystem 400 may generate and transmit credential provisioning instruction data 556 to financial institution subsystem 350 at step 506 that may also include a specific instruction for financial institution subsystem 350 to create a new virtual credential (e.g., a device primary account number (“D-PAN”)), link that virtual credential with the selected actual credential (i.e., a funding primary account number (“F-PAN”) originally issued by the issuing bank), and then provision that virtual credential onto device 100. Accordingly, in such embodiments, financial institution subsystem 350 may generate and transmit credential provisioning response data 560 back to commercial entity subsystem 400 at step 510 that may include a descriptor of the virtual credential (e.g., the D-PAN) to be provisioned and any suitable metadata that ought to be provided on device 100 for aiding user interaction with the virtual credential to be provisioned. Alternatively, in some embodiments, electronic device 100 may generate and transmit credential provisioning request data 552 at step 502 that may also include a specific instruction for financial institution subsystem 350 to create, link, and provision such a new virtual credential rather than the actual credential indicated by credential provisioning request data 552, where such a specific instruction may be passed on to financial institution subsystem 350 via credential provisioning instruction data 556 at step 506. Alternatively, in some embodiments, financial institution subsystem 350 may make a determination to create, link, and provision a new virtual credential rather than the actual credential indicated by data 552/556.

Such linking or other suitable association of a virtual credential with an actual credential may be performed by any suitable component of financial institution subsystem 350. For example, financial institution subsystem 350 (e.g., a particular payment network subsystem 360 that may be associated with the brand of the actual credential identified at step 502) may define and store an entry 702 in a virtual-linking table or data structure 352 (e.g., as shown in FIGS. 1 and 7) at step 508 of process 500, where such an entry 702 may create an association or link between the actual credential and a virtual credential. Thus, when a virtual credential is utilized by device 100 for a financial transaction with merchant subsystem 200 (e.g., after the virtual credential has been provisioned on device 100), financial institution subsystem 350 may receive an authorization request indicative of that virtual credential (e.g., as data 576, described below) and may conduct an analysis of that authorization request in light of the actual credential associated or otherwise linked with the identified virtual credential as determined by virtual-linking table 352 (e.g., at step 528 and/or step 536 of process 500, described below). By provisioning a virtual credential on device 100 rather than an actual credential, financial institution subsystem 350 may be configured to limit the fraudulent activity that may result if the virtual credential is intercepted by an unauthorized user (e.g., by an NFC communication 15 signal stealer positioned adjacent device 100 and/or merchant terminal 220), as financial institution subsystem 350 (e.g., payment network subsystem 360) may only be configured to utilize virtual-linking table 352 for linking the virtual credential to the actual credential during certain transactions (e.g., during NFC transactions received by merchant terminal 220 and not during online transactions or other transactions that may allow credential information to be manually entered by a user). Therefore, in such embodiments using a virtual credential, provisioning response data 560 generated by financial institution subsystem 350 may contain a new D-PAN (e.g., new virtual credential information) from an entry 702 in table 352 that may define a link between an F-PAN (e.g., an actual credential banking number) of the selected credential from data 552 and this new D-PAN. Provisioning response data 560 may also include the last four digits or any other suitable data of the linked F-PAN for creating a hashed version of the F-PAN. Providing both the virtual D-PAN and a hashed version of the actual F-PAN on device 100 may prevent user confusion between the two and may enable easier user association of the two when utilizing a virtual credential for a financial transaction. Therefore, in some embodiments, a full version of an F-PAN (e.g., an actual credential banking number) may never be stored on device 100, but rather only an associated D-PAN (e.g., a linked virtual credential) may be stored in non-hashed form on device 100. Provisioning response data 560 may also include a unique D-PAN hash (e.g., the last four digits of the D-PAN and/or any other suitable data for creating a hashed version of the D-PAN that may be used in all subsequent calls to reference this D-PAN while maintaining security of the D-PAN). Provisioning response data 560 may also include an “AuthToken” or any other suitable token that may be a one-time use token for enabling provision of the credential.

Next, in response to receiving credential provisioning response data 560, commercial entity subsystem 400 (e.g., SMP broker component 410) may pass some or all of the information contained in that credential provisioning response data 560 to device 100 in order to at least partially prepare device 100 for having a credential provisioned thereon. For example, at step 512 of process 500 of FIG. 5, commercial entity subsystem 400 (e.g., SMP broker component 410) may analyze the received credential provisioning response data 560 and may then generate and transmit pass data 562 to electronic device 100. Such pass data 562 may include any suitable description or identification of the credential to be provisioned (e.g., a hashed-version of the credential's PAN, virtual and/or actual (e.g., D-PAN and/or F-PAN)), as well as any associated metadata, all of which may be provided by credential provisioning response data 560 of step 510. Such pass data 562 may also include information associated with the particular SSD 154 of device 100 that may have the credential provisioned thereon (e.g., an SSD identifier of a particular SSD 154, as may be provided by step 504, which may be at least partially determined based on the secure element information provided by data 552 of step 502). Such pass data 562 may be transmitted by commercial entity subsystem 400 to electronic device 100 via communications path 65 of FIG. 1. For example, communications component 106 of electronic device 100 may be configured to receive pass data 562 using any suitable communications protocol over any suitable communications path 65.

Next, in response to receiving such pass data 562 from commercial entity subsystem 400, device 100 may be configured to generate and add a disabled pass to an SSD 154 of NFC memory module 150 (e.g., automatically, without any required user interaction at device 100). For example, at step 514 of process 500 of FIG. 5, device 100 may process received pass data 562 and may then generate and add a “disabled pass” to an SSD 154 of NFC memory module 150 (e.g., to a particular SSD 154 that may be identified by received pass data 562). At step 514, pass data 562 from step 512 may enable device 100 to make the credential seem available to device 100 for use, such as through visual logos/icons and/or any other suitable user discernible data associated with the credential and credential descriptor information that may be provided to the user (e.g., via a Passbook or Wallet application of device 100 on I/O interface 114a).

Moreover, before, after, or at least partially concurrently with step 510, financial institution subsystem 350 may initiate generation and transmission of put pending commands for commercial entity subsystem 400 and, thus, device 100. For example, at step 516 of process 500 of FIG. 5, financial institution subsystem 350 may generate and transmit put pending command data 566 to commercial entity subsystem 400 (e.g., to SMP-TSM component 420 of commercial entity subsystem 400). In some embodiments, such put pending command data 566 may include the primary account number (e.g., D-PAN or F-PAN, hashed or not) of the credential being provisioned, an SSD identifier, and/or an SSD counter. Then, in response to receiving such put pending command data 566, commercial entity subsystem 400 (e.g., SMP-TSM component 420) may issue notification data 568 to device 100 at step 518 of process 500 of FIG. 5 based on put pending command data 566. Such put pending command data 566 and/or notification data 568 may include one or more persoScripts or GlobalPlatform APDU scripts (e.g., any scripts, any rotate keys (e.g., if necessary), and any other suitable administrative elements that may be used to provision a usable PAN on device 100). At step 520, device 100 may complete any of the received scripts from notification data 568 of step 518 and/or take any other suitable action for enabling the credential (e.g., for toggling the credential from a disabled/pending activation state to an enabled/active for use state).

Therefore, the state of the secure element on device 100 (e.g., whether the credential's PAN is enabled for use in NFC component 120) may be updated at step 520 asynchronously with (e.g., later than) an availability status of the credential that may be provided to a user of device 100 (e.g., provided visually in a Passbook or Wallet application on I/O interface 114a) at step 514. This may enable the credential to appear ready for use to a user of device 100 before it is actually ready for use, thereby providing a more desirable user experience (e.g., an apparently faster provisioning time). Once the selected credential is at least disabled on device 100 (e.g., as either the actual credential or a linked virtual credential) at step 514 and/or enabled at step 520, device 100 may automatically generate a user interface that may inform the user that the credential has been successfully provisioned. For example, GUI 180 may provide a screen on I/O interface 114a, where electronic device 100 may provide a message to the user indicative of the completed provisioning and enablement of the selected credential. Alternatively, financial institution subsystem 350 may be configured to generate and transmit the contents of credential provisioning response data 560 and pending command data 566 at the same time in a single step (e.g., step 510) rather than as distinct sets of data in different steps. Additionally or alternatively, commercial entity subsystem 400 may be configured to generate and transmit the contents of pass data 562 and notification data 568 at the same time in a single step (e.g., step 518) rather than as distinct sets of data in different steps. Alternatively or additionally, although not shown in FIG. 5, additional data (e.g., a one-time password) may be communicated to device 100 prior to step 520. In some embodiments, the provisioning of a credential onto device 100 of steps 510-520 may be combined into fewer steps. For example, financial institution subsystem 350 may be configured to provision a credential directly onto device 100 without communicating via commercial entity subsystem 400 (e.g., steps 510, 512, 516, and 518 may be combined into one or more communications directly between financial institution subsystem 350 and device 100 (e.g., via communications path 75 of FIG. 1) using any suitable communications protocol or protocols). Therefore, process 500 may enable at least one selected credential to be provisioned on electronic device 100 as either an actual credential or a virtual credential linked to an actual credential by financial institution subsystem 350. Moreover, device 100 may be configured to generate and transmit process pending command data 571 to financial institution subsystem 350 directly (e.g., via communications path 75) or indirectly via commercial entity subsystem 350 (e.g., via SMP-TSM component 420) at step 521, where process pending command data 571 may indicate to financial institution subsystem 350 that the provisioning of the credential has been completed on device 100.

Once a credential has been provisioned and enabled on device 100 (e.g., at step 520), process 500 may also authenticate and use that credential in a financial transaction. Referring back to system 1 of FIG. 1, once NFC component 120 has been appropriately enabled to communicate NFC communication 15 with commerce credential data associated with an enabled credential of device 100 (e.g., actual and/or virtual commerce credential data associated with an enabled applet 153 of an SSD 154 of NFC component 120, such as due to credential provisioning steps 502-520 of process 500), merchant terminal 220 of merchant subsystem 200 may receive such a communication 15, and acquiring bank subsystem 300 may in turn receive and utilize such commerce credential data of NFC communication 15 for authenticating the use of that commerce credential data and/or completing a financial transaction with financial institution subsystem 350. For example, after a user of electronic device 100 has chosen a product for purchase and has selected a specific provisioned/enabled credential of device 100 to be used for payment, device 100 may be configured to transmit an appropriate NFC communication 15 indicative of commerce credential data for the selected credential at step 522 of process 500 of FIG. 5, where merchant terminal 220 of merchant subsystem 200 may be configured to receive NFC communication 15. Merchant subsystem 200 may be provided by any suitable merchant that may provide a product or service to a user of device 100 in response to device 100 providing payment credentials via communication 15 to merchant subsystem 200. Based on such a received NFC communication 15, merchant subsystem 200 (e.g., merchant processor 202, which may act in accordance with merchant application 203) may be configured to generate and transmit (e.g., via merchant communications component 206) merchant attempted purchase data 574 to acquiring bank subsystem 300 (e.g., via a communication path 25 between merchant subsystem 200 and acquiring bank subsystem 300) at step 524 of process 500 of FIG. 5, where merchant attempted purchase data 574 may include payment information and an authorization request that may be indicative of the user's commerce credential (e.g., the PAN of the credential of NFC communication 15) and the merchant's purchase price for the product or service. Also known as a payment processor or acquirer, acquiring bank subsystem 300 may be a banking partner of the merchant associated with merchant subsystem 200, and acquiring bank subsystem 300 may be configured to work with financial institution subsystem 350 to approve and settle credential transactions attempted by electronic device 100 via NFC communication 15 with merchant subsystem 200. In response to receiving merchant attempted purchase data 574 at step 524, acquiring bank subsystem 300 may then forward the authorization request from attempted purchase data 574 to financial institution subsystem 350 as acquiring bank attempted purchase data 576 (e.g., via a communication path 35 between acquiring bank subsystem 300 and financial institution subsystem 350) at step 526 of process 500 of FIG. 5, where acquiring bank attempted purchase data 576 may include payment information and an authorization request that may be indicative of the user's commerce credential (e.g., the PAN of the credential of NFC communication 15) and the merchants purchase price for the product or service, and/or information indicative of the merchants bank account with acquiring bank subsystem 300. One, some, or all components of acquiring bank subsystem 300 may be implemented using one or more processor components, which may be the same as or similar to processor component 102 of device 100, one or more memory components, which may be the same as or similar to memory component 104 of device 100, and/or one or more communications components, which may be the same as or similar to communications component 106 of device 100.

When financial institution subsystem 350 receives an authorization request (e.g., from acquiring bank subsystem 300 as acquiring bank attempted purchase data 576), the payment information may be analyzed by financial institution subsystem 350 at step 528 of process 500 of FIG. 5 to determine whether or not the identified commerce credential has been authenticated for use in a financial transaction. For example, if the commerce credential information of communication 15 transmitted from device 100 and included in acquiring bank attempted purchase data 576 is indicative of a virtual credential (e.g., a D-PAN), financial institution subsystem 350 may consult or otherwise leverage virtual-linking data structure 352 or any other suitable data to determine whether or not the link between the virtual credential and its associated actual credential (i.e., its associated F-PAN) has been authenticated in one or more suitable ways before allowing the associated actual credential to be used during the attempted financial transaction (e.g., to actually fund the transaction). Rather than requiring a user of device 100 to authenticate that he or she is the rightful owner of an actual credential selected at step 502 during the provisioning of an associated virtual credential on device 100 (e.g., by providing personal user-identifiable information from device 100 to financial institution subsystem 350 (e.g., to an issuing bank subsystem 370) at step 502 or elsewhere during the provisioning of an associated virtual credential on device 100, where such personal user-identifiable information may be authenticated by issuing bank subsystem 370 based on verified user information already known to issuing bank subsystem 370 in association with the actual credential), process 500 may be configured to enable a user of device 100 to authenticate that he or she is the rightful owner of an actual credential associated with a provisioned virtual credential during an attempted financial transaction (e.g., after the virtual credential has been provisioned on device 100, such as after step 521). Therefore, one or more ways may be provided by process 500 for authenticating a user of a virtual credential with an actual credential after the virtual credential has been provisioned on the user's device 100, where such authentication may occur during an attempted financial transaction using the provisioned virtual credential.

As mentioned, in response to receiving virtual commerce credential data in an authorization request (e.g., from acquiring bank subsystem 300 as acquiring bank attempted purchase data 576), financial institution subsystem 350 may leverage virtual-linking data structure 352 or any other suitable data to determine whether or not the link between that virtual credential and its associated actual credential (i.e., its associated F-PAN) has been authenticated in one or more suitable ways such that the virtual credential may be used in a financial transaction. For example, as shown in FIG. 7, and as described in more detail below with respect to process 500′ of FIG. 5A, data structure 352 may include one or more entries 702, where each entry 702 may include a specific virtual credential or D-PAN 704 linked with an actual credential or F-PAN 706 (e.g., as may be created at step 508). Moreover, as shown in FIG. 7, each entry 702 of data structure 352 may include a link authentication status 708, which may indicate whether or not the link between the virtual credential or D-PAN 704 and the actual credential or F-PAN 706 of that entry 702 is currently authenticated such that the virtual credential may be used in a financial transaction. When a specific virtual credential or D-PAN 704 is initially linked with an actual credential or F-PAN 706 in a new entry 702 of data structure 352 (e.g., at step 508 of process 500 during the provisioning of that virtual credential on device 100), the link authentication status 708 of that entry 702 may be initially set as “not authenticated” (e.g., as shown by entry 702a), whereby such a status may be later accessed by financial institution subsystem 350 (e.g., at step 528 of process 500 during an attempted financial transaction) to determine that the link between the specific virtual credential or D-PAN 704 and actual credential or F-PAN 706 of that entry 702 must be authenticated before that specific virtual credential or D-PAN 704 may be used to complete the attempted financial transaction and/or before the link authentication status 708 of that entry 702 may be updated to “authenticated” (e.g., as shown by entry 702b). Data structure 352 may be any suitable database or any suitable ordered data storage that may be accessible in any suitable way to system 1 (e.g., to financial institution subsystem 350).

Therefore, in response to receiving virtual commerce credential data in an authorization request (e.g., from acquiring bank subsystem 300 as acquiring bank attempted purchase data 576), financial institution subsystem 350 may leverage virtual-linking data structure 352 at step 528 of process 500 to determine whether or not the link between that virtual credential (e.g., as indicated by a matching D-PAN 704 of a particular entry 702) and its associated actual credential (e.g., as indicated by the F-PAN 706 of that entry 702) has been authenticated (e.g., as indicated by the link authentication status 708 of that entry 702). If at step 528 it is determined that a link between the virtual credential identified in an attempted financial transaction and an associated actual credential is authenticated, process 500 may jump to step 538, whereby that associated actual credential may be used to fund the financial transaction, as described in more detail below. However, if at step 528 it is determined that a link between the virtual credential identified in an attempted financial transaction and an associated actual credential is not authenticated, process 500 may proceed to step 530, whereby system 1 may attempt to appropriately authenticate that link.

A link between a virtual credential provisioned on electronic device 100 and an associated actual credential may be authenticated in various suitable ways. For example, in some embodiments, financial institution subsystem 350 may leverage merchant subsystem 200 in order to attempt to acquire suitable information from a user of device 100 that may appropriate authentication of the user to the linked actual credential. As shown in FIG. 5, at step 530 of process 500, financial institution subsystem may generate and transmit authentication request data 580 to merchant subsystem 200, either directly (e.g., via communications path 85 of FIG. 1 using any suitable communications protocol) or indirectly via acquiring bank subsystem 300 (e.g., via communications paths 35 and 25 of FIG. 1 using any suitable communications protocol or protocols). Authentication request data 580 may be a simple instruction that may identify the particular target merchant subsystem 200 (e.g., the same merchant terminal subsystem 200 that transmitted merchant attempted purchase data 574 to acquiring bank subsystem 300 that resulted in the acquiring bank attempted purchase data 576 received by financial institution subsystem 350 and relied upon for previous step 528). Alternatively or additionally, authentication request data 580 may include information describing one or more questions or prompts that seek one or more answers that may be used to authenticate the link (e.g., “Please Enter PIN Associated with Credential Being Used”, “What is Maiden Name of User's Mother?”, etc.). Alternatively or additionally, authentication request data 580 may include information indicative of one or both of the virtual credential and the actual credential whose non-authenticated link was identified at step 528 (e.g., a complete or hashed version of D-PAN 704 and/or a complete or hashed version of F-PAN 706).

Next, in response to receiving such authentication request data 580 (e.g., at merchant communications component 206 of FIG. 1), merchant subsystem 200 may be configured to prompt the user of device 100 to provide information responsive to the authentication request. For example, at step 532 of process 500, merchant subsystem 200 may be configured to display or otherwise communicate a request for authentication information to a user of device 100 (e.g., via merchant I/O interface 214, as it may be assumed that a user of device 100 may be proximate to merchant subsystem 200 due to device 100 having recently transmitted NFC communication 15 to merchant subsystem 200 at step 522). As just one example, merchant I/O interface 214 may be similar to touch screen I/O interface 114a of device 100 of FIG. 3, where merchant I/O interface 214 may be configured to display one or more questions to a user of device 100 and to receive a response from such a user via user input at that merchant I/O interface 214. The one or more questions posed at step 532 may request that the user enter personal user-identifiable information that may be authenticated by financial institution subsystem 350 (e.g., issuing bank subsystem 370) based on verified user information already known to financial institution subsystem 350 in association with the actual credential identified at step 528 (e.g., a personal identification number (“PIN”), the maiden name of the user's mother, or any other suitable personal information that financial institution subsystem 350 may already have associated with the actual credential). The one or more questions posed at step 532 may identify one or both of the virtual credential and the actual credential whose non-authenticated link was identified at step 528 (e.g., a complete or hashed version of D-PAN 704 and/or a complete or hashed version of F-PAN 706), which may help the user recollect the correct authentication information to be provided.

Next, in response to receiving such user authentication information at step 532 (e.g., via merchant I/O interface 214), merchant subsystem 200 may be configured to generate and transmit data indicative of the user's response back to financial institution subsystem 350. For example, at step 534 of process 500, merchant subsystem 200 may be configured to generate and transmit authentication response data 584 (e.g., via merchant communications component 206) indicative of the user's authentication information back to financial institution subsystem 350, either directly (e.g., via communications path 85 of FIG. 1 using any suitable communications protocol) or indirectly via acquiring bank subsystem 300 (e.g., via communications paths 25 and 35 of FIG. 1 using any suitable communications protocol or protocols). Authentication response data 584 may be any suitable data indicative of the authentication information provided by a user of device 100 to merchant subsystem 200 in response to merchant subsystem 200 prompting the user for authentication information at step 532. For example, in some embodiments, authentication response data 584 may include not only the one or more answers received from the user of device 100 at step 532, but also identification of one or both of the virtual credential and the actual credential whose non-authenticated link was identified at step 528 (e.g., a complete or hashed version of D-PAN 704 and/or a complete or hashed version of F-PAN 706). In some other embodiments, authentication request 580 may be sent from financial institution subsystem 350 to electronic device 100, such that device 100 may be configured to prompt the user of device 100 to provide information responsive to the authentication request at step 532, and such that device 100 may then be configured to generate and transmit authentication response data 584 indicative of the user's response back to financial institution subsystem 350. In yet other embodiments, authentication request 580 may be sent from financial institution subsystem 350 to merchant subsystem 200, and merchant subsystem 200 may then forward at least a portion of that request 580 to electronic device 100, such that device 100 (and/or device 100 and merchant subsystem 200) may be configured to prompt the user of device 100 to provide information responsive to the authentication request at step 532, and such that device 100 may then be configured to generate and transmit authentication response data 584 indicative of the user's response back to merchant subsystem 200 for eventual forwarding on to financial institution subsystem 350.

Next, in response to receiving such authentication response data 584 from merchant subsystem 200, financial institution subsystem 350 may be configured to determine whether or not the user's answer(s) may appropriately authenticate the user to the actual credential or F-PAN 706 identified at step 528 and thus appropriately authenticate the non-authenticated link between the virtual credential and the actual credential identified at step 528. For example, at step 536 of process 500, financial institution subsystem 350 may be configured to receive authentication response data 584 from merchant subsystem 200 and to determine whether or not the user's answer(s) provided by that authentication response data 584 may be used to authenticate the user to the actual credential or F-PAN 706 identified at step 528 (e.g., by comparing the user's response of authentication response data 584 with verified user information already known to financial institution subsystem 350 in association with the actual credential identified at step 528 (e.g., particular verified user information that may already be known by and accessible to an issuing bank subsystem 370 that originally issued the actual credential to its rightful user)). If at step 536 it is determined by financial institution subsystem 350 that authentication response data 584 is not able to authenticate a user of device 100 with the actual credential identified at step 528, then the link between that actual credential and the particular virtual credential also identified at step 528 may remain non-authenticated (e.g., by maintaining the link authentication status 708 of the appropriate entry 702 of data structure 352 that links that actual credential and that virtual credential as “not authenticated”) and then process 500 may return to step 530 in order to once again attempt to authenticate the link or process 500 may proceed with any other suitable course of action. However, if at step 536 it is determined by financial institution subsystem 350 that authentication response data 584 is able to authenticate a user of device 100 with the actual credential identified at step 528, then the link between that actual credential and the particular virtual credential also identified at step 528 may be authenticated (e.g., by updating the link authentication status 708 of the appropriate entry 702 of data structure 352 that links that actual credential and that virtual credential from “not authenticated” to “authenticated”) and process 500 may proceed to step 538, whereby that associated and authenticated actual credential may be used to fund the financial transaction. Therefore, an actual credential may be identified as the basis for credential provisioning on device 100 (e.g., at step 502), then a virtual credential may be associated or linked with that actual credential (e.g., at step 508), and then that virtual credential may be provisioned on device 100 (e.g., at steps 510-520), where such provisioning may occur without device 100 or a user of device 100 providing any information for authenticating the link between that virtual credential and the actual credential and/or for authenticating the user's association to the actual credential. Then, after the actual credential has been identified, after the virtual credential has been associated or linked with that actual credential, and after that virtual credential has been provisioned on device 100, the link between that virtual credential and that actual credential may be authenticated (e.g., at steps 528-536). Such authentication may not require any interaction with device 100 (e.g., any user interaction and/or any communication between device 100 and any subsystem of system 1). Moreover, such authentication may not require any alteration of data on device 100, any removal of data from device 100, and/or any addition of data onto device 100.

Various other types of data may be generated and/or stored by financial institution subsystem 350 (e.g., in data structure 352) in response to analyzing received authentication response data 584 at step 536. For example, as shown in FIG. 7, each entry 702 of data structure 352 may include authentication data 710, which may be indicative of any suitable type of information or multiple types of information associated with the authentication of the link between D-PAN 704 and F-PAN 706 of that entry 702. As just one example, authentication data 710 for a particular entry 702 (e.g., <AUTHENTICATION1> data 710 for entry 702a) may be indicative of the time at which the link for that entry 702 was authenticated (e.g., the time at which link authentication status 708 for that entry 702 changed from “not authenticated” to “authenticated”), where such authentication data 710 may be utilized by financial institution subsystem 350 to manage the authentication status 708 of the entry 702 in any suitable way (e.g., the authentication status 708 of an entry 702 may automatically change from “authenticated” to “not authenticated” if a particular amount of time passes since that entry was last authenticated). This may enable financial institution subsystem 350 to routinely require user authentication of a credential at any suitable interval of time. Additionally or alternatively, authentication data 710 for a particular entry 702 may be indicative of how many failed authentication attempts have occurred for that entry 702 (e.g., the number of times that step 536 was not able to use received authentication response data 584 for authenticating a link of an intended entry 702), where such authentication data 710 may be utilized by financial institution subsystem 350 to maintain, delete, or otherwise adjust the link of that entry 702 (e.g., an entry 702 linking a particular D-PAN 704 to a particular F-PAN 706 may be deleted from data structure 352 if a particular number of failed authentication attempts have occurred for that link). This may enable financial institution subsystem 350 to render a previously provisioned virtual credential useless if a user is unable to authenticate its link with an actual credential after a certain number of attempts.

When financial institution subsystem 350 identifies an authenticated link between a particular virtual credential (e.g., of acquiring bank attempted purchase data 576) and an associated actual credential (e.g., through leveraging data structure 352 at step 528 and/or step 536), process 500 may proceed to step 538, whereby that associated actual credential may be used by financial institution subsystem 350 to attempt to fund the requested financial transaction. For example, if financial institution subsystem 350 may leverage table 352 to determine that the commerce credential information of NFC communication 15 between device 100 and merchant terminal 220 is indicative of a virtual credential (e.g., a D-PAN 704 of data structure 352) that has an authenticated link to an actual credential (e.g., an associated F-PAN 706 of data structure 352), then financial institution subsystem 350 may determine at step 538 whether the account associated with that actual credential or F-PAN 706 has enough credit to cover the purchase amount of the attempted financial transaction (e.g., as may be identified by acquiring bank attempted purchase data 576). If sufficient funds are not present, financial institution subsystem 350 may decline the requested transaction by transmitting negative authorization response data 588 to acquiring bank subsystem 300 at step 538. However, if sufficient funds are present, financial institution subsystem 350 may approve the requested transaction by transmitting positive authorization response data 588 to acquiring bank subsystem 300 at step 538 and the financial transaction may be completed. Either type of authorization response may be provided by financial institution subsystem 350 to acquiring bank subsystem 300 as authorization response data 588 (e.g., via communications path 35 using any suitable communications protocol) at step 538 of process 500 of FIG. 5. Then, such authorization response data 588 may be utilized by acquiring bank subsystem 300 (e.g., to apply credit to the bank account of the merchant of merchant subsystem 200 at acquiring bank subsystem 300 with funds from the account associated with the actual commerce credential or F-PAN 706), and associated authorization response data 589 may be may be provided by acquiring bank subsystem 300 to merchant subsystem 200 (e.g., via communications path 25) based on authorization response data 388 at step 539 of process 500 of FIG. 5, where any suitable data indicative of the financial transaction may then be provided to a user of device 100 via merchant subsystem 200 (e.g., via merchant I/O interface 214).

It is understood that the steps shown in process 500 of FIG. 5 are merely illustrative and that existing steps may be modified or omitted, additional steps may be added, and the order of certain steps may be altered.

### Description of FIG. 5A

As mentioned, financial institution subsystem 350 may include a payment network subsystem 360 (e.g., a payment card association or a credit card association) and/or an issuing bank subsystem 370, where payment network subsystem 360 and issuing bank subsystem 370 may be a single entity or separate entities. For example, American Express may be both a payment network subsystem 360 and an issuing bank subsystem 370. In contrast, Visa and MasterCard may be payment network subsystems 360, and may work in cooperation with issuing bank subsystems 370, such as Chase, Wells Fargo, Bank of America, and the like. In instances where payment network subsystem 360 and issuing bank subsystem 370 may be separate entities, payment network subsystem 360 and issuing bank subsystem 370 may communicate with one another to ensure proper authentication of a link between a virtual credential and an actual credential and/or to complete the financial transaction. For example, as shown in FIG. 5A, a process 500A may be similar to process 500 of FIG. 5 but with various communications between a particular payment network subsystem 360 and a particular issuing bank subsystem 370 of a particular financial institution subsystem 350. Although process 500A is shown being implemented by various elements of system 1 (e.g., merchant subsystem 200, acquiring bank subsystem 300, a particular payment network subsystem 360, and a particular issuing bank subsystem 370), it is to be understood that process 500A may be implemented using any other suitable components or subsystems.

As shown in FIG. 5A, steps 524-534 of process 500A may be substantially similar or identical to steps 524-534 of process 500 described above. For example, as shown, payment network subsystem 360 may be configured to receive acquiring bank attempted purchase data 576 transmitted from acquiring bank subsystem 300 at step 526, to determine whether or not a link between a virtual credential of data 576 and an actual credential has been authenticated for use in a financial transaction (e.g., by leveraging data structure 352) at step 528, to transmit authentication request data 580 at step 530, and/or to receive authentication response data 584 transmitted at step 534. Moreover, steps 538 and 539 of process 500A may be substantially similar or identical to steps 538 and 539 of process 500 described above. For example, as shown in FIG. 5A, payment network subsystem 360 may be configured to transmit authorization response data 588 to acquiring bank subsystem 300 at step 538. However, as also shown in FIG. 5A, after payment network subsystem 360 may receive authentication response data 584 from merchant subsystem 200 at step 534, but before payment network subsystem 360 may transmit authorization response data 588 to acquiring bank subsystem 300 at step 538, process 500′ may include steps 536a-536e, where payment network subsystem 360 and particular issuing bank subsystem 370 may work together to ensure proper authentication of a link between a virtual credential and an actual credential and/or to complete the financial transaction.

As with process 500, rather than requiring a user of device 100 to authenticate that he or she is the rightful owner of an actual credential selected during the provisioning of an associated virtual credential on device 100 (e.g., by providing personal user-identifiable information from device 100 to financial institution subsystem 350 during the provisioning of an associated virtual credential on device 100, where such personal user-identifiable information may be authenticated by financial institution subsystem 350 based on verified user information already known to financial institution subsystem 350 in association with the actual credential), process 500A may be configured to enable a user of device 100 to authenticate that he or she is the rightful owner of an actual credential associated with a provisioned virtual credential during an attempted financial transaction. However, when payment network subsystem 360 may be provided in system 1 as an interface between issuing bank subsystem 370 and various acquiring bank subsystems 300 (e.g., to minimize direct integration points of financial institution subsystem 350 by acting as an aggregator for various issuing banks 370 and/or for various acquiring banks 300 (e.g., during financial transactions)) and/or as an interface between issuing bank subsystem 370 and various commercial entity subsystems 400/devices 100 (e.g., to minimize direct integration points of financial institution subsystem 350 by acting as an aggregator for various issuing banks 370 and/or for various commercial entity subsystems 400/devices 100 (e.g., during credential provisioning)), it may be burdensome for such a payment network subsystem 360 to authenticate a user with an actual credential, as verified personal user-identifiable information associated with the actual credential may not be accessible to payment network subsystem 360 (e.g., such verified personal user-identifiable information associated with the actual credential may only be accessible by a particular issuing bank subsystem 370 that originally issued that actual credential). Therefore, as shown by steps 536a-536e of process 500A, payment network subsystem 360 and particular issuing bank subsystem 370 may work together to ensure proper authentication of a link between a virtual credential and an actual credential and/or to complete the financial transaction.

At step 536a of process 500, payment network subsystem 360 may be configured to receive authentication response data 584 from merchant subsystem 200 and to associate such authentication response data 584 with the appropriate actual credential (e.g., the F-PAN 706 identified at step 528), for example, by storing such authentication response data 584 in the appropriate entry 702 of data structure 352 that may include the D-PAN 704 identified at step 528). Next, at step 536b, payment network subsystem 360 may be configured to transmit authentication/transaction request data 586b to a particular issuing bank subsystem 370 (e.g., via communications path 45 of FIG. 1 using any suitable communications protocol), where the particular issuing bank subsystem may be identified by payment network subsystem 360 (e.g., at step 536a) as the issuing bank subsystem responsible for issuing the actual credential (e.g., the F-PAN 706 identified at step 528). Such authentication/transaction request data 586b may include authentication response data 584, identification of the actual credential (e.g., the F-PAN 706 identified at step 528), as well as any suitable information from attempted purchase data 576 (e.g., the merchant's purchase price for the product or service at the center of the attempted financial transaction). Next, at step 536c, a particular issuing bank subsystem 370 may receive such authentication/transaction request data 586b and determine whether or not the actual credential (e.g., the F-PAN 706 identified at step 528) ought to be authenticated for use in the attempted financial transaction (e.g., the attempted financial transaction using a virtual credential associated with that actual credential by payment network subsystem 360 (e.g., in data structure 352). For example, issuing bank subsystem 370 may be configured to receive such authentication/transaction request data 586b and to compare the user's authentication response data 584 and F-PAN 706 of authentication/transaction request data 586b with particular verified user information that may already be known by and accessible to issuing bank subsystem 370 for that F-PAN 706. For example, such verified user information may be stored in any suitable memory component of issuing bank subsystem 370 that may be similar to memory component 104 of device 100, where such verified user information may not be shared by issuing bank subsystem 370 with other subsystems (e.g., issuing bank subsystem 370 may not share such verified user information with payment network subsystem 360).

If it is determined by issuing bank subsystem 370 at step 536c that authentication response data 584 identified by authentication/transaction request data 586b is not able to authenticate the actual credential or F-PAN 706 identified by authentication/transaction request data 586b, then issuing bank subsystem 370 may generate and transmit a first type of authentication/transaction response data 586d to payment network subsystem 360 at step 536d (e.g., via communications path 45 of FIG. 1 using any suitable communications protocol). This first type of authentication/transaction response data 586d may be indicative of the determination by issuing bank subsystem 370 that authentication response data 584 is not able to authenticate the actual credential or F-PAN 706, and payment network subsystem 360 may receive and utilize such first type of authentication/transaction response data 586d at step 536e. Payment network subsystem 360 may utilize this first type of authentication/transaction response data 586d at step 536e to ensure that the link between that actual credential or F-PAN 706 and the particular virtual credential also identified at step 528 is non-authenticated (e.g., by setting or maintaining the link authentication status 708 of the appropriate entry 702 of data structure 352 that links that actual credential and that virtual credential as “not authenticated”). Then, process 500A may return to step 530 in order to once again attempt to authenticate the link or process 500A may proceed with any other suitable course of action.

However, if it is determined by issuing bank subsystem 370 at step 536c that authentication response data 584 identified by authentication/transaction request data 586b is able to authenticate the actual credential or F-PAN 706 identified by authentication/transaction request data 586b, then issuing bank subsystem 370 may also determine at step 536c whether the account associated with that actual credential or F-PAN 706 has enough credit to cover the purchase amount of the attempted financial transaction (e.g., as may be identified by authentication/transaction request data 586b). If issuing bank subsystem 370 determines at step 536c that sufficient funds are not present, financial institution subsystem 350 may decline the requested transaction by generating and transmitting a second type of authentication/transaction response data 586d to payment network subsystem 360 at step 536d (e.g., via communications path 45 of FIG. 1 using any suitable communications protocol). This second type of authentication/transaction response data 586d may be indicative of the determination by issuing bank subsystem 370 that authentication response data 584 is able to authenticate the actual credential or F-PAN 706 but that the associated account is unable to fund the attempted transaction, and payment network subsystem 360 may receive and utilize such second type of authentication/transaction response data 586d at step 536e. Payment network subsystem 360 may utilize this second type of authentication/transaction response data 586d at step 536e to ensure that the link between that actual credential or F-PAN 706 and the particular virtual credential also identified at step 528 is authenticated (e.g., by setting the link authentication status 708 of the appropriate entry 702 of data structure 352 that links that actual credential and that virtual credential as “authenticated”). Then, process 500A may proceed to step 538, whereby payment network subsystem 360 may decline the requested transaction by transmitting negative authorization response data 588 to acquiring bank subsystem 300.

However, if it is determined by issuing bank subsystem 370 at step 536c that authentication response data 584 identified by authentication/transaction request data 586b is able to authenticate the actual credential or F-PAN 706 identified by authentication/transaction request data 586b and that sufficient funds are present to cover the purchase amount of the attempted financial transaction, financial institution subsystem 350 may accept the requested transaction by generating and transmitting a third type of authentication/transaction response data 586d to payment network subsystem 360 at step 536d (e.g., via communications path 45 of FIG. 1 using any suitable communications protocol). This third type of authentication/transaction response data 586d may be indicative of the determination by issuing bank subsystem 370 that authentication response data 584 is able to authenticate the actual credential or F-PAN 706 and that the associated account is able to fund the attempted transaction, and payment network subsystem 360 may receive and utilize such third type of authentication/transaction response data 586d at step 536e. Payment network subsystem 360 may utilize this third type of authentication/transaction response data 586d at step 536e to ensure that the link between that actual credential or F-PAN 706 and the particular virtual credential also identified at step 528 is authenticated (e.g., by setting the link authentication status 708 of the appropriate entry 702 of data structure 352 that links that actual credential and that virtual credential as “authenticated”). Then, process 500A may proceed to step 538, whereby payment network subsystem 360 may accept the requested transaction by transmitting positive authorization response data 588 to acquiring bank subsystem 300.

Moreover, in some embodiments, prior to generating authentication request 580 at step 530 in response to receiving authorization request 576 at step 526, payment network subsystem 360 may request certain authentication request data from issuing bank subsystem 370 that may be associated with the F-PAN linked to the D-PAN identified by authorization request 576. That is, prior to communicating authentication request 580 to merchant subsystem 200 in an attempt to get authentication data from a user for authenticating the link between an identified D-PAN and a linked F-PAN, payment network subsystem 360 may request from issuing bank subsystem 370 what type of information is known to issuing bank subsystem 370 about the F-PAN that may be used to authenticate the link, such as security data that may be used to authenticate the link (e.g., known maiden name of the owner of the F-PAN, etc.) and payment network subsystem 360 may then leverage that information from issuing bank subsystem 370 to generate an appropriate and effective authentication request 580 (e.g., by providing steps similar to steps 536a-536e between step 526 and step 530).

It is understood that the steps shown in process 500A of FIG. 5A are merely illustrative and that existing steps may be modified or omitted, additional steps may be added, and the order of certain steps may be altered.

### Description of FIG. 6

FIG. 6 is a flowchart of an illustrative process 600 for provisioning a credential on an electronic device. At step 602, process 600 may create a link between an actual commerce credential and a virtual commerce credential. For example, as described above with respect to FIGS. 5 and 5A, financial institution subsystem 350 may be configured to create a link between an actual commerce credential and a virtual commerce credential at step 508 of process 500. Next, at step 604, after the link has been created, process 600 may facilitate the provisioning of the virtual commerce credential on an electronic device. For example, as described above with respect to FIGS. 5 and 5A, financial institution subsystem 350 may be configured to facilitate provisioning of the virtual credential linked at step 508 onto electronic device 100 directly and/or via commercial entity subsystem 400 at steps 510-520 of process 500. Next, at step 606, after the provisioning, process 600 may authenticate the link between the actual commerce credential and the virtual commerce credential. For example, as described above with respect to FIGS. 5 and 5A, financial institution subsystem 350 may be configured to authenticate a previously created link between a virtual commerce credential and an actual commerce credential at step 536 of process 500 and/or steps 536a-536e of process 500A.

It is understood that the steps shown in process 600 of FIG. 6 are merely illustrative and that existing steps may be modified or omitted, additional steps may be added, and the order of certain steps may be altered.

### Description of FIG. 7

As mentioned, FIG. 7 shows an illustrative data structure 352 of the system of FIG. 1 that may store data in one or more entries 702 for use in provisioning and/or authenticating credentials on electronic device 100. Although data structure 352 may take the form of a table in a relational database in the example of FIG. 7, any other data structure may be used in other embodiments. Data structure 352 may store various types of information and may be stored on or otherwise accessible by financial institution subsystem (e.g., payment network subsystem 360 (e.g., in a memory component of payment network subsystem 360 that may be similar to memory component 104 of device 100)). As shown, each one of entries 702a-702d may include its own row spanning each one of D-PAN column 704, F-PAN column 706, link authentication status column 708, and authentication data column 710. Each row of D-PAN column 704 may include a unique value or an identifier associated with a unique value that may distinguish one D-PAN or virtual credential from another within data structure 352. For example, as shown, a first virtual credential “D-PAN1” of column 704 for entry 702a may have a unique identifier or unique D-PAN (e.g., 12345678), a second virtual credential “D-PAN2” of column 704 for entry 702b may have a unique identifier or unique D-PAN (e.g., 34567812), a third virtual credential “D-PAN3” of column 704 for entry 702c may have a unique identifier or unique D-PAN (e.g., 56781234), and a fourth virtual credential “D-PAN4” of column 704 for entry 702d may have a unique identifier or unique D-PAN (e.g., 78123456).

Although each entry 702 of data structure 352 may be associated with a unique D-PAN of column 704, two or more entries 702 may be associated with the same actual credential or F-PAN of column 706. For example, as shown, a first actual credential “F-PAN1” of column 706 for entry 702a may have an identifier or F-PAN (e.g., 23456781) and a second actual credential “F-PAN2” of column 706 for entry 702b may have an identifier or F-PAN (e.g., 45678123), while a third actual credential “F-PAN3” of column 706 may have an identifier or F-PAN (e.g., 67812345) for each one of entries 702c and 702d. That is, a single actual credential (i.e., “F-PAN3”) may be linked with two different virtual credentials (i.e., “D-PAN3” and “D-PAN4”) of two different entries (i.e., entries 702c and 702d) of data structure 352, such that a user may provision a first virtual credential on a first device 100 and a second virtual credential on a second device 100 where both virtual credentials are linked to the same single actual credential.

Each row of link authentication status column 708 may include a value or an identifier associated with a value that may indicate that the link between the D-PAN of column 704 and the F-PAN of column 706 for that same row (e.g., for that particular entry 702) is “authenticated” or “not authenticated”. As shown in FIG. 7, for example, a single actual credential (i.e., “F-PAN3”) may be linked with two different virtual credentials (i.e., “D-PAN3” and “D-PAN4”) of two different entries (i.e., entries 702c and 702d) of data structure 352, yet one of those links may be authenticated while the other may not be authenticated (e.g., the link between F-PAN3 and D-PAN3 may be authenticated while the link between F-PAN3 and D-PAN4 may not be authenticated. As mentioned various types of authentication data may be associated with each entry 702. For example, each row of authentication data column 710 may include a value or an identifier associated with a value that may be indicative of one or more suitable types of information (e.g., <AUTHENTICATION1> for entry 702a, <AUTHENTICATION2> for entry 702b, <AUTHENTICATION3> for entry 702c, and <AUTHENTICATION4> for entry 702d).

### Further Description of FIG. 2 and FIG. 3

As mentioned, and as shown in FIG. 2, electronic device 100 can include, but is not limited to, a music player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, or any combination thereof. In some embodiments, electronic device 100 may perform a single function (e.g., a device dedicated to conducting financial transactions) and, in other embodiments, electronic device 100 may perform multiple functions (e.g., a device that conducts financial transactions, plays music, and receives and transmits telephone calls). Electronic device 100 may be any portable, mobile, hand-held, or miniature electronic device that may be configured to conduct financial transactions wherever a user travels. Some miniature electronic devices may have a form factor that is smaller than that of hand-held electronic devices, such as an iPod™. Illustrative miniature electronic devices can be integrated into various objects that may include, but are not limited to, watches, rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include a processor 102, memory 104, communications component 106, power supply 108, input component 110, output component 112, antenna 116, and near field communication (“NFC”) component 120. Electronic device 100 may also include a bus 118 that may provide one or more wired or wireless communication links or paths for transferring data and/or power to, from, or between various other components of device 100. In some embodiments, one or more components of electronic device 100 may be combined or omitted. Moreover, electronic device 100 may include other components not combined or included in FIG. 2. For example, electronic device 100 may include any other suitable components or several instances of the components shown in FIG. 2. For the sake of simplicity, only one of each of the components is shown in FIG. 2.

Memory 104 may include one or more storage mediums, including for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated on one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, any other suitable data, or any combination thereof.

Communications component 106 may be provided to allow device 100 to communicate with one or more other electronic devices or servers or subsystems (e.g., one or more subsystems or other components of system 1) using any suitable communications protocol. For example, communications component 106 may support Wi-Fi (e.g., an 802.11 protocol), ZigBee (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 106 may also include or be electrically coupled to any suitable transceiver circuitry (e.g., transceiver circuitry or antenna 116 via bus 118) that can enable device 100 to be communicatively coupled to another device (e.g., a host computer or an accessory device) and communicate with that other device wirelessly, or via a wired connection (e.g., using a connector port). Communications component 106 may be configured to determine a geographical position of electronic device 100. For example, communications component 106 may utilize the global positioning system (“GPS”) or a regional or site-wide positioning system that may use cell tower positioning technology or Wi-Fi technology.

Power supply 108 can include any suitable circuitry for receiving and/or generating power, and for providing such power to one or more of the other components of electronic device 100. For example, power supply 108 can be coupled to a power grid (e.g., when device 100 is not acting as a portable device or when a battery of the device is being charged at an electrical outlet with power generated by an electrical power plant). As another example, power supply 108 can be configured to generate power from a natural source (e.g., solar power using solar cells). As another example, power supply 108 can include one or more batteries for providing power (e.g., when device 100 is acting as a portable device). For example, power supply 108 can include one or more of a battery (e.g., a gel, nickel metal hydride, nickel cadmium, nickel hydrogen, lead acid, or lithium-ion battery), an uninterruptible or continuous power supply (“UPS” or “CPS”), and circuitry for processing power received from a power generation source (e.g., power generated by an electrical power plant and delivered to the user via an electrical socket or otherwise). The power can be provided by power supply 108 as alternating current or direct current, and may be processed to transform power or limit received power to particular characteristics. For example, the power can be transformed to or from direct current, and constrained to one or more values of average power, effective power, peak power, energy per pulse, voltage, current (e.g., measured in amperes), or any other characteristic of received power. Power supply 108 can be operative to request or provide particular amounts of power at different times, for example, based on the needs or requirements of electronic device 100 or periphery devices that may be coupled to electronic device 100 (e.g., to request more power when charging a battery than when the battery is already charged).

One or more input components 110 may be provided to permit a user to interact or interface with device 100. For example, input component 110 can take a variety of forms, including, but not limited to, a touch pad, dial, click wheel, scroll wheel, touch screen, one or more buttons (e.g., a keyboard), mouse, joy stick, track ball, microphone, camera, scanner (e.g., a bar code scanner or any other suitable scanner that may obtain product identifying information from a code, such as a bar code, a QR code, or the like), proximity sensor, light detector, motion sensor, biometric sensor (e.g., a fingerprint reader or other feature recognition sensor, which may operate in conjunction with a feature-processing application that may be accessible to electronic device 100 for authenticating a user), and combinations thereof. Each input component 110 can be configured to provide one or more dedicated control functions for making selections or issuing commands associated with operating device 100.

Electronic device 100 may also include one or more output components 112 that may present information (e.g., graphical, audible, and/or tactile information) to a user of device 100. For example, output component 112 of electronic device 100 may take various forms, including, but not limited to, audio speakers, headphones, audio line-outs, visual displays, antennas, infrared ports, haptic output components (e.g., rumblers, vibrators, etc.), or combinations thereof.

As a specific example, electronic device 100 may include a display output component as output component 112. Such a display output component may include any suitable type of display or interface for presenting visual data to a user. A display output component may include a display embedded in device 100 or coupled to device 100 (e.g., a removable display). A display output component may include, for example, a liquid crystal display (“LCD”), a light emitting diode (“LED”) display, an organic light-emitting diode (“OLED”) display, a surface-conduction electron-emitter display (“SED”), a carbon nanotube display, a nanocrystal display, any other suitable type of display, or combination thereof. Alternatively, a display output component can include a movable display or a projecting system for providing a display of content on a surface remote from electronic device 100, such as, for example, a video projector, a head-up display, or a three-dimensional (e.g., holographic) display. As another example, a display output component may include a digital or mechanical viewfinder, such as a viewfinder of the type found in compact digital cameras, reflex cameras, or any other suitable still or video camera. A display output component may include display driver circuitry, circuitry for driving display drivers, or both, and such a display output component can be operative to display content (e.g., media playback information, application screens for applications implemented on electronic device 100, information regarding ongoing communications operations, information regarding incoming communications requests, device operation screens, etc.) that may be under the direction of processor 102.

It should be noted that one or more input components and one or more output components may sometimes be referred to collectively herein as an input/output (“I/O”) component or I/O interface (e.g., input component 110 and output component 112 as I/O component or I/O interface 114). For example, input component 110 and output component 112 may sometimes be a single I/O component 114, such as a touch screen, that may receive input information through a user's touch of a display screen and that may also provide visual information to a user via that same display screen.

Processor 102 of electronic device 100 may include any processing circuitry that may be operative to control the operations and performance of one or more components of electronic device 100. For example, processor 102 may receive input signals from input component 110 and/or drive output signals through output component 112. As shown in FIG. 2, processor 102 may be used to run one or more applications, such as an application 103, an application 113, and/or an application 113. Each application 103/113/143 may include, but is not limited to, one or more operating system applications, firmware applications, media playback applications, media editing applications, NFC low power mode applications, biometric feature-processing applications, or any other suitable applications. For example, processor 102 may load application 103/113/143 as a user interface program to determine how instructions or data received via an input component 110 or other component of device 100 may manipulate the way in which information may be stored and/or provided to the user via an output component 112. Application 103/113/143 may be accessed by processor 102 from any suitable source, such as from memory 104 (e.g., via bus 118) or from another device or server (e.g., via communications component 106). Processor 102 may include a single processor or multiple processors. For example, processor 102 may include at least one “general purpose” microprocessor, a combination of general and special purpose microprocessors, instruction set processors, graphics processors, video processors, and/or related chips sets, and/or special purpose microprocessors. Processor 102 also may include on board memory for caching purposes.

Electronic device 100 may also include near field communication (“NFC”) component 120. NFC component 120 may be any suitable proximity-based communication mechanism that may enable contactless proximity-based transactions or communications 15 between electronic device 100 and merchant subsystem 200 (e.g., a merchant payment terminal). NFC component 120 may allow for close range communication at relatively low data rates (e.g., 424 kbps), and may comply with any suitable standards, such as ISO/IEC 7816, ISO/IEC 18092, ECMA-340, ISO/IEC 21481, ECMA-352, ISO 14443, and/or ISO 15693. Alternatively or additionally, NFC component 120 may allow for close range communication at relatively high data rates (e.g., 370 Mbps), and may comply with any suitable standards, such as the TransferJet™ protocol. Communication between NFC component 120 and merchant subsystem 200 may occur within any suitable close range distance between device 100 and merchant subsystem 200 (see, e.g., distance D of FIG. 1), such as a range of approximately 2 to 4 centimeters, and may operate at any suitable frequency (e.g., 13.56 MHz). For example, such close range communication of NFC component 120 may take place via magnetic field induction, which may allow NFC component 120 to communicate with other NFC devices and/or to retrieve information from tags having radio frequency identification (“RFID”) circuitry. NFC component 120 may provide a manner of acquiring merchandise information, transferring payment information, and otherwise communicating with an external device (e.g., terminal 220 of merchant subsystem 200).

NFC component 120 may include any suitable modules for enabling contactless proximity-based communication 15 between electronic device 100 and merchant subsystem 200. As shown in FIG. 2, for example, NFC component 120 may include an NFC device module 130, an NFC controller module 140, and an NFC memory module 150.

NFC device module 130 may include an NFC data module 132, an NFC antenna 134, and an NFC booster 136. NFC data module 132 may be configured to contain, route, or otherwise provide any suitable data that may be transmitted by NFC component 120 to merchant subsystem 200 as part of a contactless proximity-based or NFC communication 15. Additionally or alternatively, NFC data module 132 may be configured to contain, route, or otherwise receive any suitable data that may be received by NFC component 120 from merchant subsystem 200 as part of a contactless proximity-based communication 15.

NFC transceiver or NFC antenna 134 may be any suitable antenna or other suitable transceiver circuitry that may generally enable communication of communication 15 from NFC data module 132 to merchant subsystem 200 and/or to NFC data module 132 from subsystem 200. Therefore, NFC antenna 134 (e.g., a loop antenna) may be provided specifically for enabling the contactless proximity-based communication capabilities of NFC component 120.

Alternatively or additionally, NFC component 120 may utilize the same transceiver circuitry or antenna (e.g., antenna 116) that another communication component of electronic device 100 (e.g., communication component 106) may utilize. For example, communication component 106 may leverage antenna 116 to enable Wi-Fi, Bluetooth™, cellular, or GPS communication between electronic device 100 and another remote entity, while NFC component 120 may leverage antenna 116 to enable contactless proximity-based or NFC communication 15 between NFC data module 132 of NFC device module 130 and another entity (e.g., merchant subsystem 200). In such embodiments, NFC device module 130 may include NFC booster 136, which may be configured to provide appropriate signal amplification for data of NFC component 120 (e.g., data within NFC data module 132) so that such data may be appropriately transmitted by shared antenna 116 as communication 15 to subsystem 200. For example, shared antenna 116 may require amplification from booster 136 before antenna 116 (e.g., a non-loop antenna) may be properly enabled for communicating contactless proximity-based or NFC communication 15 between electronic device 100 and merchant subsystem 200 (e.g., more power may be needed to transmit NFC data using antenna 116 than may be needed to transmit other types of data using antenna 116).

NFC controller module 140 may include at least one NFC processor module 142. NFC processor module 142 may operate in conjunction with NFC device module 130 to enable, activate, allow, and/or otherwise control NFC component 120 for communicating NFC communication 15 between electronic device 100 and merchant subsystem 200. NFC processor module 142 may exist as a separate component, may be integrated into another chipset, or may be integrated with processor 102, for example, as part of a system on a chip (“SoC”). As shown in FIG. 2, NFC processor module 142 of NFC controller module 140 may be used to run one or more applications, such as an NFC low power mode or wallet application 143 that may help dictate the function of NFC component 120. Application 143 may include, but is not limited to, one or more operating system applications, firmware applications, NFC low power applications, or any other suitable applications that may be accessible to NFC component 120 (e.g., application 103/113). NFC controller module 140 may include one or more protocols, such as the Near Field Communication Interface and Protocols (“NFCIP-1”), for communicating with another NFC device (e.g., merchant subsystem 200). The protocols may be used to adapt the communication speed and to designate one of the connected devices as the initiator device that controls the near field communication.

NFC controller module 140 may control the near field communication mode of NFC component 120. For example, NFC processor module 142 may be configured to switch NFC device module 130 between a reader/writer mode for reading information (e.g., communication 15) from NFC tags (e.g., from merchant subsystem 200) to NFC data module 132, a peer-to-peer mode for exchanging data (e.g., communication 15) with another NFC enabled device (e.g., merchant subsystem 200), and a card emulation mode for allowing another NFC enabled device (e.g., merchant subsystem 200) to read information (e.g., communication 15) from NFC data module 132. NFC controller module 140 also may be configured to switch NFC component 120 between active and passive modes. For example, NFC processor module 142 may be configured to switch NFC device module 130 (e.g., in conjunction with NFC antenna 134 or shared antenna 116) between an active mode where NFC device module 130 may generate its own RF field and a passive mode where NFC device module 130 may use load modulation to transfer data to another device generating an RF field (e.g., merchant subsystem 200). Operation in such a passive mode may prolong the battery life of electronic device 100 compared to operation in such an active mode. The modes of NFC device module 130 may be controlled based on preferences of a user and/or based on preferences of a manufacturer of device 100, which may be defined or otherwise dictated by an application running on device 100 (e.g., application 103 and/or application 143).

NFC memory module 150 may operate in conjunction with NFC device module 130 and/or NFC controller module 140 to allow for NFC communication 15 between electronic device 100 and merchant subsystem 200. NFC memory module 150 may be embedded within NFC device hardware or within an NFC integrated circuit (“IC”). NFC memory module 150 may be tamper resistant and may provide at least a portion of a secure element. For example, NFC memory module 150 may store one or more applications relating to NFC communications (e.g., application 143) that may be accessed by NFC controller module 140. For example, such applications may include financial payment applications, secure access system applications, loyalty card applications, and other applications, which may be encrypted. In some embodiments, NFC controller module 140 and NFC memory module 150 may independently or in combination provide a dedicated microprocessor system that may contain an operating system, memory, application environment, and security protocols intended to be used to store and execute sensitive applications on electronic device 100. NFC controller module 140 and NFC memory module 150 may independently or in combination provide at least a portion of a secure element, which may be tamper resistant. For example, such a secure element may be configured to provide a tamper-resistant platform (e.g., as a single or multiple chip secure microcontroller) that may be capable of securely hosting applications and their confidential and cryptographic data (e.g., applet 153 and key 155) in accordance with rules and security requirements that may be set forth by a set of well-identified trusted authorities (e.g., an authority of financial institution subsystem and/or an industry standard, such as GlobalPlatform). NFC memory module 150 may be a portion of memory 106 or at least one dedicated chip specific to NFC component 120. NFC memory module 150 may reside on a SIM, a dedicated chip on a motherboard of electronic device 100, or as an external plug in memory card. NFC memory module 150 may be completely independent from NFC controller module 140 and may be provided by different components of device 100 and/or provided to electronic device 100 by different removable subsystems.

NFC memory module 150 may include one or more of an issuer security domain (“ISD”) 152 and a supplemental security domain (“SSD”) 154 (e.g., a service provider security domain (“SPSD”), a trusted service manager security domain (“TSMSD”), etc.), which may be defined and managed by an NFC specification standard (e.g., GlobalPlatform). For example, ISD 152 may be a portion of NFC memory module 150 in which a trusted service manager (“TSM”) or issuing financial institution may store keys and/or other suitable information for creating or otherwise provisioning one or more credentials (e.g., credentials associated with various credit cards, bank cards, gift cards, access cards, transit passes, digital currency (e.g., bitcoin and associated payment networks), etc.) on electronic device 100 (e.g., via communications component 106), for credential content management, and/or security domain management. A specific supplemental security domain (“SSD”) 154 (e.g., one of SSDs 154-154b) may be associated with a specific credential (e.g., a specific credit card credential or a specific public transit card credential) that may provide specific privileges or payment rights to electronic device 100. Each SSD 154 may have its own manager key 155 for its own application or applet 153 that may need to be activated to enable a specific credential of that SSD 154 for use by NFC device module 130 as an NFC communication 15 between electronic device 100 and merchant subsystem 200. For example, a particular SSD 154 may be associated with a particular credit card credential. However, that particular credential may only be communicated as an NFC communication 15 to merchant subsystem 200 by NFC component 120 (e.g., that particular credential may only be accessible by NFC data module 132) when a particular applet 153 of that particular SSD 154 has been enabled or otherwise activated or unlocked for such use. Security features may be provided for enabling use of NFC component 120 that may be particularly useful when transmitting confidential payment information, such as credit card information or bank account information of a credential, from electronic device 100 to merchant subsystem 200 as NFC communication 15. Such security features also may include a secure storage area that may have restricted access. For example, user authentication via personal identification number (“PIN”) entry or via user interaction with a biometric sensor may need to be provided to access the secure storage area. In certain embodiments, some or all of the security features may be stored within NFC memory module 150. Further, security information, such as an authentication key, for communicating with subsystem 200 may be stored within NFC memory module 150. In certain embodiments, NFC memory module 150 may include a microcontroller embedded within electronic device 100.

While NFC component 120 has been described with respect to near field communication, it is to be understood that component 120 may be configured to provide any suitable contactless proximity-based mobile payment or any other suitable type of contactless proximity-based communication 15 between electronic device 100 and merchant subsystem 200. For example, NFC component 120 may be configured to provide any suitable short-range communication, such as those involving electromagnetic/electrostatic coupling technologies.

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 110 may be an independent keyboard or mouse within its own housing that may wirelessly or through a wire communicate with processor 102, which may be provided within its own housing).

As mentioned, and as shown in FIG. 3, one specific example of electronic device 100 may be a handheld electronic device, such as an iPhone™, where housing 101 may allow access to various input components 110a-110i, various output components 112a-112c, and various I/O components 114a-114d through which device 100 and a user and/or an ambient environment may interface with each other. Input component 110a may include a button that, when pressed, may cause a “home” screen or menu of a currently running application to be displayed by device 100. Input component 110b may be a button for toggling electronic device 100 between a sleep mode and a wake mode or between any other suitable modes. Input component 110c may include a two-position slider that may disable one or more output components 112 in certain modes of electronic device 100. Input components 110d and 110e may include buttons for increasing and decreasing the volume output or any other characteristic output of an output component 112 of electronic device 100. Each one of input components 110a-110e may be a mechanical input component, such as a button supported by a dome switch, a sliding switch, a control pad, a key, a knob, a scroll wheel, or any other suitable form.

An output component 112a may be a display that can be used to display a visual or graphic user interface (“GUI”) 180, which may allow a user to interact with electronic device 100. GUI 180 may include various layers, windows, screens, templates, elements, menus, and/or other components of a currently running application (e.g., application 103 and/or application 143) that may be displayed in all or some of the areas of display output component 112a. For example, as shown in FIG. 3, GUI 180 may be configured to display a first screen 190. One or more of user input components 110a-110i may be used to navigate through GUI 180. For example, one user input component 110 may include a scroll wheel that may allow a user to select one or more graphical elements or icons 182 of GUI 180. Icons 182 may also be selected via a touch screen I/O component 114a that may include display output component 112a and an associated touch input component 110f Such a touch screen I/O component 114a may employ any suitable type of touch screen input technology, such as, but not limited to, resistive, capacitive, infrared, surface acoustic wave, electromagnetic, or near field imaging. Furthermore, touch screen I/O component 114a may employ single point or multi-point (e.g., multi-touch) input sensing.

Icons 182 may represent various layers, windows, screens, templates, elements, and/or other components that may be displayed in some or all of the areas of display component 112a upon selection by the user. Furthermore, selection of a specific icon 182 may lead to a hierarchical navigation process. For example, selection of a specific icon 182 may lead to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. For example, when the specific icon 182 labeled with a “Setup Assistant” textual indicator 181 (i.e., specific icon 183) is selected, device 100 may launch or otherwise access a specific setup application and may display screens of a specific user interface that may include one or more tools or features for interacting with device 100 in a specific manner. For each application, screens may be displayed on display output component 112a and may include various user interface elements. Additionally or alternatively, for each application, various other types of non-visual information may be provided to a user via various other output components 112 of device 100. The operations described with respect to various GUIs 180 may be achieved with a wide variety of graphical elements and visual schemes. Therefore, the described embodiments are not intended to be limited to the precise user interface conventions adopted herein. Rather, embodiments may include a wide variety of user interface styles.

Electronic device 100 also may include various other I/O components 114 that may allow for communication between device 100 and other devices. I/O component 114b may be a connection port that may be configured for transmitting and receiving data files, such as media files or customer order files, from a remote data source and/or power from an external power source. For example, I/O component 114b may be a proprietary port, such as a Lightning™ connector or a 30-pin dock connector from Apple Inc. of Cupertino, Calif. I/O component 114c may be a connection slot for receiving a SIM card or any other type of removable component. I/O component 114d may be a headphone jack for connecting audio headphones that may or may not include a microphone component. Electronic device 100 may also include at least one audio input component 110g, such as a microphone, and at least one audio output component 112b, such as an audio speaker.

Electronic device 100 may also include at least one haptic or tactile output component 112c (e.g., a rumbler), a camera and/or scanner input component 110h (e.g., a video or still camera, and/or a bar code scanner or any other suitable scanner that may obtain product identifying information from a code, such as a bar code, a QR code, or the like), and a biometric input component 110i (e.g., a fingerprint reader or other feature recognition sensor, which may operate in conjunction with a feature-processing application that may be accessible to electronic device 100 for authenticating a user). As shown in FIG. 3, at least a portion of biometric input component 110i may be incorporated into or otherwise combined with input component 110a or any other suitable input component 110 of device 100. For example, biometric input component 110i may be a fingerprint reader that may be configured to scan the fingerprint of a user's finger as the user interacts with mechanical input component 110a by pressing input component 110a with that finger. As another example, biometric input component 110i may be a fingerprint reader that may be combined with touch input component 110f of touch screen I/O component 114a, such that biometric input component 110i may be configured to scan the fingerprint of a user's finger as the user interacts with touch screen input component 110f by pressing or sliding along touch screen input component 110f with that finger. Moreover, as mentioned, electronic device 100 may further include NFC component 120, which may be communicatively accessible to subsystem 200 via antenna 116 and/or antenna 134 (not shown in FIG. 3). NFC component 120 may be located at least partially within housing 101, and a mark or symbol 121 can be provided on the exterior of housing 101 that may identify the general location of one or more of the antennas associated with NFC component 120 (e.g., the general location of antenna 116 and/or antenna 134).

Moreover, one, some, or all of the processes described with respect to FIGS. 1-7 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 and/or memory module 150 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol (e.g., the computer-readable medium may be communicated to electronic device 100 via communications component 106 (e.g., as at least a portion of application 103 and/or as at least a portion of application 113 and/or as at least a portion of application 143)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are merely illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of application 103 and/or as at least a portion of application 113 and/or as at least a portion of application 143)). For example, any or each module of NFC component 120 may be implemented using any suitable technologies (e.g., as one or more integrated circuit devices), and different modules may or may not be identical in structure, capabilities, and operation. Any or all of the modules or other components of system 1 may be mounted on an expansion card, mounted directly on a system motherboard, or integrated into a system chipset component (e.g., into a “north bridge” chip).

Any or each module or component of system 1 (e.g., any or each module of NFC component 120) may be a dedicated system implemented using one or more expansion cards adapted for various bus standards. For example, all of the modules may be mounted on different interconnected expansion cards or all of the modules may be mounted on one expansion card. With respect to NFC component 120, by way of example only, the modules of NFC component 120 may interface with a motherboard or processor 102 of device 100 through an expansion slot (e.g., a peripheral component interconnect (′PCI″) slot or a PCI express slot). Alternatively, NFC component 120 need not be removable but may include one or more dedicated modules that may include memory (e.g., RAM) dedicated to the utilization of the module. In other embodiments, NFC component 120 may be integrated into device 100. For example, a module of NFC component 120 may utilize a portion of device memory 104 of device 100. Any or each module or component of system 1 (e.g., any or each module of NFC component 120) may include its own processing circuitry and/or memory. Alternatively, any or each module or component of system 1 (e.g., any or each module of NFC component 120) may share processing circuitry and/or memory with any other module of NFC component 120 and/or processor 102 and/or memory 104 of device 100.

As mentioned, an input component 110 of device 100 (e.g., input component 1100 may include a touch input component that can receive touch input for interacting with other components of device 100 via wired or wireless bus 118. Such a touch input component 110 may be used to provide user input to device 100 in lieu of or in combination with other input components, such as a keyboard, mouse, and the like.

A touch input component 110 may include a touch sensitive panel, which may be wholly or partially transparent, semitransparent, non-transparent, opaque, or any combination thereof. A touch input component 110 may be embodied as a touch screen, touch pad, a touch screen functioning as a touch pad (e.g., a touch screen replacing the touchpad of a laptop), a touch screen or touch pad combined or incorporated with any other input device (e.g., a touch screen or touch pad disposed on a keyboard), or any multi-dimensional object having a touch sensitive surface for receiving touch input. In some embodiments, the terms touch screen and touch pad may be used interchangeably.

In some embodiments, a touch input component 110 embodied as a touch screen may include a transparent and/or semitransparent touch sensitive panel partially or wholly positioned over, under, and/or within at least a portion of a display (e.g., display output component 112a). In other embodiments, a touch input component 110 may be embodied as an integrated touch screen where touch sensitive components/devices are integral with display components/devices. In still other embodiments, a touch input component 110 may be used as a supplemental or additional display screen for displaying supplemental or the same graphical data as a primary display and to receive touch input.

A touch input component 110 may be configured to detect the location of one or more touches or near touches based on capacitive, resistive, optical, acoustic, inductive, mechanical, chemical measurements, or any phenomena that can be measured with respect to the occurrences of the one or more touches or near touches in proximity to input component 110. Software, hardware, firmware, or any combination thereof may be used to process the measurements of the detected touches to identify and track one or more gestures. A gesture may correspond to stationary or non-stationary, single or multiple, touches or near touches on a touch input component 110. A gesture may be performed by moving one or more fingers or other objects in a particular manner on touch input component 110, such as by tapping, pressing, rocking, scrubbing, rotating, twisting, changing orientation, pressing with varying pressure, and the like at essentially the same time, contiguously, or consecutively. A gesture may be characterized by, but is not limited to, a pinching, pulling, sliding, swiping, rotating, flexing, dragging, or tapping motion between or with any other finger or fingers. A single gesture may be performed with one or more hands, by one or more users, or any combination thereof.

As mentioned, electronic device 100 may drive a display (e.g., display output component 112a) with graphical data to display a graphical user interface (“GUI”) 180. GUI 180 may be configured to receive touch input via a touch input component 110f. Embodied as a touch screen (e.g., with display output component 112a as I/O component 114a), touch I/O component 110f may display GUI 180. Alternatively, GUI 180 may be displayed on a display (e.g., display output component 112a) separate from touch input component 110f. GUI 180 may include graphical elements displayed at particular locations within the interface. Graphical elements may include, but are not limited to, a variety of displayed virtual input devices, including virtual scroll wheels, a virtual keyboard, virtual knobs, virtual buttons, any virtual user interface (“UI”), and the like. A user may perform gestures at one or more particular locations on touch input component 110f, which may be associated with the graphical elements of GUI 180. In other embodiments, the user may perform gestures at one or more locations that are independent of the locations of graphical elements of GUI 180. Gestures performed on a touch input component 110 may directly or indirectly manipulate, control, modify, move, actuate, initiate, or generally affect graphical elements, such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad may generally provide indirect interaction. Gestures may also affect non-displayed GUI elements (e.g., causing user interfaces to appear) or may affect other actions of device 100 (e.g., affect a state or mode of a GUI, application, or operating system). Gestures may or may not be performed on a touch input component 110 in conjunction with a displayed cursor. For instance, in the case in which gestures are performed on a touchpad, a cursor or pointer may be displayed on a display screen or touch screen and the cursor or pointer may be controlled via touch input on the touchpad to interact with graphical objects on the display screen. In other embodiments, in which gestures are performed directly on a touch screen, a user may interact directly with objects on the touch screen, with or without a cursor or pointer being displayed on the touch screen. Feedback may be provided to the user via bus 118 in response to or based on the touch or near touches on a touch input component 110. Feedback may be transmitted optically, mechanically, electrically, olfactory, acoustically, or the like or any combination thereof and in a variable or non-variable manner.

### FURTHER APPLICATIONS OF DESCRIBED CONCEPTS

While there have been described systems, methods, and computer-readable media for securely provisioning and/or authenticating credentials on an electronic device, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A financial institution system in communication with an electronic device and a merchant subsystem, the financial institution system comprising:
at least one processor component;
at least one memory component; and
at least one communications component, wherein the financial institution system is configured to:
create a link between an actual commerce credential and a virtual commerce credential;
provision the virtual commerce credential on the electronic device;
after the virtual commerce credential is provisioned on the electronic device, receive a transaction request from the merchant subsystem;
identify the virtual commerce credential from the received transaction request; and
in response to the identification of the virtual commerce credential, determine if the link between the actual commerce credential and the virtual commerce credential is authenticated for use in a financial transaction.

2. The financial institution system of claim 1, wherein the financial institution system is further configured to authenticate the link between the actual commerce credential and the virtual commerce credential by instructing the merchant subsystem to request user information from a user of the electronic device when it is determined that the link between the actual commerce credential and the virtual commerce credential is not authenticated.

3. The financial institution system of claim 1, wherein the financial institution system is further configured to authenticate the link between the actual commerce credential and the virtual commerce credential, when it is determined that the link between the actual commerce credential and the virtual commerce credential is not authenticated, by:
instructing the merchant subsystem to request user information from a user of the electronic device;
receiving the user information; and
comparing the received user information to verified information.

4. The financial institution system of claim 1, wherein the financial institution system is further configured to fund the received transaction request using the actual commerce credential when it is determined that the link between the actual commerce credential and the virtual commerce credential is authenticated.

5. The financial institution system of claim 1, wherein the financial institution system is configured to provision the virtual commerce credential on the electronic device without receiving from the electronic device any authentication information associated with the actual commerce credential.

6. A method comprising:
creating with a financial institution subsystem a link between an actual commerce credential and a virtual commerce credential;
after the creating, facilitating the provisioning of the virtual commerce credential on an electronic device using the financial institution subsystem; and
after the provisioning of the virtual commerce credential on the electronic device, authenticating the link between the actual commerce credential and the virtual commerce credential using the financial institution subsystem.

7. The method of claim 6, further comprising:
receiving with the financial institution subsystem a transaction request from a merchant subsystem;
identifying with the financial institution subsystem the virtual commerce credential from the received transaction request; and
in response to the identification of the virtual commerce credential, determining with the financial institution subsystem if the link between the actual commerce credential and the virtual commerce credential is authenticated.

8. The method of claim 7, wherein, when it is determined that the link between the actual commerce credential and the virtual commerce credential is not authenticated, the authenticating comprises the financial institution subsystem instructing the merchant subsystem to request user information from a user of the electronic device.

9. The method of claim 7, wherein, when it is determined that the link between the actual commerce credential and the virtual commerce credential is not authenticated, the authenticating comprises the financial institution subsystem:
instructing the merchant subsystem to request user information from a user of the electronic device;
receiving the user information; and
comparing the received user information to verified information.

10. The method of claim 7, wherein, when it is determined that the link between the actual commerce credential and the virtual commerce credential is not authenticated, the method further comprises the financial institution subsystem funding the received transaction request using the actual commerce credential.

11. The method of claim 6, further comprising enabling the electronic device to use the provisioned virtual commerce credential for funding a purchase with the actual commerce credential without requiring the electronic device to communicate any authentication information associated with the actual commerce credential.

12. A merchant system in communication with an electronic device and a financial institution subsystem, the merchant system comprising:
a processor component;
a memory component; and
a communications component, wherein the merchant system is configured to:
receive a contactless proximity-based communication from the electronic device;
transmit information indicative of a device commerce credential of the received communication to the financial institution subsystem;
receive an authorization request from the financial institution subsystem based on the transmitted information; and
prompt a user of the electronic device to provide authentication information for an actual commerce credential based on the received authorization request.

13. The merchant system of claim 12, wherein the transmitted information is further indicative of a purchase price associated with the received communication.

14. The merchant system of claim 12, wherein the device commerce credential is a virtual commerce credential.

15. The merchant system of claim 14, wherein the merchant system is further configured to:
receive the authentication information from the user; and
send the received authentication information to the financial institution subsystem.

16. The merchant system of claim 15, wherein the received authentication information is configured to authenticate a link between the virtual commerce credential and the actual commerce credential.

17. A financial institution system in communication with a merchant subsystem, the financial institution system comprising:
at least one processor component;
at least one memory component; and
at least one communications component, wherein the financial institution system is configured to:
receive a virtual commerce credential from a merchant subsystem;
detect a link between the received virtual commerce credential and an actual commerce credential; and
determine if the detected link is authenticated.

18. The financial institution system of claim 17, wherein the financial institution system is configured to detect the link by using the received virtual commerce credential and a data structure stored in the at least one memory component.

19. The financial institution system of claim 18, wherein the financial institution system is configured to determine if the detected link is authenticated by using the data structure.

20. The financial institution system of claim 17, wherein the financial institution system is further configured to instruct the merchant subsystem to request authentication information from a user when it is determined that the detected link is not authenticated.

21. The financial institution system of claim 17, wherein the financial institution system is further configured to receive from the merchant subsystem authentication information associated with the actual commerce credential.

22. A non-transitory computer-readable medium comprising computer-readable instructions recorded thereon for:
detecting a link between a virtual commerce credential and an actual commerce credential; and
determining if the detected link is authenticated.

23. The non-transitory computer-readable medium of claim 22, further comprising additional computer-readable instructions recorded thereon for authenticating the detected link using authentication information associated with the actual commerce credential.

24. A financial institution system in communication with at least one of an electronic device and a merchant subsystem, the financial institution system comprising:
at least one processor component;
at least one memory component; and
at least one communications component, wherein the financial institution system is configured to:
create a link between an actual commerce credential and a virtual commerce credential;
facilitate the provisioning of the virtual commerce credential on the electronic device; and
authenticate the link between the actual commerce credential and the virtual commerce credential after the provisioning of the virtual commerce credential on the electronic device.

25. The financial institution system of claim 24, wherein the financial institution system is configured to facilitate the provisioning of the virtual commerce credential on the electronic device without receiving from the electronic device any authentication information associated with the actual commerce credential.

26. The financial institution system of claim 24, wherein the financial institution system is configured to authenticate the link between the actual commerce credential and the virtual commerce credential for a set duration of time.

27. The financial institution system of claim 24, comprising:
a payment network subsystem comprising:
a first processor component of the at least one processor component;
a first memory component of the at least one memory component; and
a first communications component of the at least one communications component; and
an issuing bank subsystem comprising:
a second processor component of the at least one processor component;
a second memory component of the at least one memory component; and
a second communications component of the at least one communications component, wherein:
the payment network subsystem is configured to:
receive a transaction request from the merchant subsystem;
identify the virtual commerce credential from the received transaction request;
in response to the identification of the virtual commerce credential, determine if the link between the actual commerce credential and the virtual commerce credential is authenticated; and
instruct the merchant subsystem to request user information from a user of the electronic device when it is determined that the link between the actual commerce credential and the virtual commerce credential is not authenticated, and
the issuing bank subsystem is configured to:
receive the user information; and
authenticate the link between the actual commerce credential and the virtual commerce credential based on the received user information.

28. The financial institution system of claim 27, wherein the payment network subsystem is configured to determine if the link between the actual commerce credential and the virtual commerce credential is authenticated by consulting a data structure stored in the first memory component.

29. The financial institution system of claim 27, wherein the issuing bank subsystem is configured to authenticate the link between the actual commerce credential and the virtual commerce credential by comparing the received user information with verified user information stored in the second memory component.

30. The financial institution system of claim 27, wherein:
the payment network subsystem is configured to determine if the link between the actual commerce credential and the virtual commerce credential is authenticated by consulting a data structure stored in the first memory component;
the issuing bank subsystem is configured to authenticate the link between the actual commerce credential and the virtual commerce credential by comparing the received user information with verified user information stored in the second memory component;
the issuing bank subsystem is further configured to send a positive authentication indication to the payment network subsystem when the issuing bank subsystem authenticates the link between the actual commerce credential and the virtual commerce credential; and
the payment network subsystem is further configured to:
receive the positive authentication indication from the issuing bank subsystem; and
update the data structure based on the received positive authentication indication.

31. The financial institution system of claim 24, comprising:
a payment network subsystem comprising:
a first processor component of the at least one processor component;
a first memory component of the at least one memory component; and
a first communications component of the at least one communications component; and
an issuing bank subsystem comprising:
a second processor component of the at least one processor component;
a second memory component of the at least one memory component; and
a second communications component of the at least one communications component, wherein:
the payment network subsystem is configured to:
receive a transaction request from the merchant subsystem;
identify the virtual commerce credential from the received transaction request;
in response to the identification of the virtual commerce credential, determine if the link between the actual commerce credential and the virtual commerce credential is authenticated; and
send to the issuing bank subsystem a funding request indicative of a purchase price from the received transaction request and indicative of the actual commerce credential when it is determined that the link between the actual commerce credential and the virtual commerce credential is authenticated; and
the issuing bank subsystem is configured to:
receive the funding request; and
attempt to fund the purchase price with the actual commerce credential.
